(19) United States
(12) Patent Application Publication
(10) Pub. No.: US 2014/0036343 A1
(43) Pub. Date: Feb. 6, 2014

(54) INTERFEROMETRIC MODULATOR WITH IMPROVED PRIMARY COLORS

(71) Applicants: Jian J. Ma, Carlsbad, CA (US); John H. Hong, San Clemente, CA (US); Yuriy Reznik, San Diego, CA (US)

(72) Inventors: Jian J. Ma, Carlsbad, CA (US); John H. Hong, San Clemente, CA (US); Yuriy Reznik, San Diego, CA (US)

(73) Assignee: Qualcomm Mems Technologies, Inc., San Diego, CA (US)

(21) Appl. No.: 13/563,473

(22) Filed: Jul. 31, 2012

(51) Int. Cl. G02B 26/02; G06T 1/00; H01J 9/00; B82Y 20/00

(52) U.S. Cl. 359/291; 445/24; 345/501; 977/952

(57) ABSTRACT

This disclosure provides systems, methods and apparatus related to an electromechanical display device. In one aspect, an analog interferometric modulator includes a display pixel having a movable reflector, and a movable absorbing layer. The movable absorbing layer is positionable at a variable first distance from an electrode that is substantially transparent over a visible wavelength spectrum. The movable reflector is positionable at a variable second distance from the movable absorbing layer. Changing the first distance and the second distance changes a characteristic of light reflected from the display element.

### TECHNICAL FIELD

This disclosure relates to electromechanical systems. Specifically, this disclosure relates to interferometric modulators (IMODs) including two interferometric gaps for controlling light reflected from the IMODs.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electromechanical device that includes a substantially transparent over a visible wavelength spectrum first electrode disposed on a substrate, a light-absorbing, partially transmissive movable stack including a second electrode, the movable stack being positionable at a variable first distance from the first electrode to form a variable first gap between the movable stack and the first electrode, wherein the device is configured to move the movable stack to at least two different positions, each position being a different distance from the first electrode, and a movable reflector including a third electrode, the movable reflector disposed such that the movable stack is between the first electrode and the movable reflector and such that the movable reflector is at a variable second distance from the movable stack to form a variable second gap between the movable reflector and the movable stack, wherein the device is configured to move the movable reflector to a plurality of positions such that the second distance is between about zero (0) nm and 650 nm. Such a device can further include a fourth electrode disposed such that the movable reflector is between the fourth electrode and the movable stack. The device may be configured to move the movable stack to change the first distance to either one of two different distances. In some implementations, the at least two different positions place the movable stack at a minimum distance from the first electrode when the movable stack is in an actuated state and a maximum distance from the first electrode when the movable stack is in a relaxed state. In some implementations, the device is configured to position the movable reflector and the movable stack such that the second distance is between about 10 nm and 650 nm and the first distance is at either between about zero (0) nm and 10 nm or between about 100 nm and 200 nm. The movable reflector may include, in relative order, a layer of metal film, a layer of low refractive index thin film, a layer of high refractive index dielectric film. The movable reflector further includes a mechanically supporting dielectric layer disposed such that the layer of high refractive index dielectric film is between the mechanically supporting dielectric layer and the low refractive index thin film. In some implementations, the layer of metal film may include aluminum (Al), the layer of low refractive index thin film includes silicon oxynitride (SiON), and the layer of high refractive index dielectric film includes titanium dioxide (TiO₂), and the mechanical supporting dielectric layer includes silicon oxynitride (SiON).

In some implementations, the movable stack may include, in relative order, a layer of passivation thin film, a layer of absorbing metal film, a layer of low refractive index thin film, a layer of high refractive index film, and a second layer of thin film with its refractive index identical to the substrate material, the second layer of thin film having a thickness dimension of between about 150 nm and 250 nm. In some devices, the layer of passivation thin film includes aluminum oxide (Al₂O₃)), the layer of absorbing metal film includes vanadium (V), the layer of low refractive index thin film includes silicon dioxide (SiO₂), the layer of high refractive index film includes silicon nitride (Si₃N₄), and the second layer of thin film includes silicon dioxide (SiO₂). Some implementations of the device may be configured to apply a voltage across the movable stack and the first electrode to adjust the first distance, and wherein the device is configured to apply a voltage across the movable reflector and the movable stack to adjust the second distance. And in some implementations, the device is configured to adjust the second distance to one of at least five unique distances.

Another innovative aspect of the subject matter includes an electromechanical display device including a transmissive first electrode substantially transparent over a visible wavelength spectrum disposed on a substrate, a movable means for partially transmitting and partially absorbing light positionable at a variable first distance from the first electrode to form a variable first gap between the movable stack and the first electrode, wherein the display device is configured to move the partially transmitting and partially absorbing means to at least two different positions, each position being a different distance from the first electrode, and means for reflecting light disposed such that the movable means is between the first electrode and the reflecting means, and the reflecting means positionable at a variable second distance from the movable means to form a variable second gap between the movable means and the means for reflecting light, wherein the display device is configured to move the reflecting means to a plurality of positions such that the second distance is between 10 nm and 650 nm.

Another innovative aspect includes a method of forming an electromechanical apparatus, the method including forming a first electrode that is substantially transparent over a visible wavelength spectrum on a substrate, forming a sacrificial layer over the first electrode, forming a first support structure, forming a first light absorbing, partially transmissive movable stack including a second electrode, forming a sacrificial layer over the first light absorbing, partially transmissive, movable stack, forming a movable reflector including a third electrode, forming a second support structure, and forming a first gap between the first electrode and the first movable stack and a second gap between the first movable stack and the movable reflector. The method may further include forming a sacrificial layer over the movable reflector, forming a fourth electrode, forming a third support structure, and forming a third gap between the movable reflector and the fourth electrode.

Another innovative aspect includes a non-transitory, computer readable storage medium having instructions stored thereon that cause a processing circuit to perform a method of displaying light on a display element, including changing a variable first gap to between 0 and 10 nm or between 150 nm and 250 nm, the first gap defined on one side by a first electrode that is substantially transparent in a visible wavelength spectrum, and on the other side by a light-absorbing, partially transmissive movable stack including a second electrode, changing a variable second gap to between 0 and 650 nm, the second gap defined on one side by the light-absorbing, partially transmissive movable stack and on another side by a movable reflector including a third electrode, and receiving light such that at least a portion of the received light propagates through the first gap and the second gap, reflects from the movable reflector and propagates back through the second gap and first gap and out of the display element, and a portion of the received light is reflected by the movable stack and propagates out of the display element, the first gap and the second gap changes a characteristic of light reflected from the display element. The saturated colors may be reflected from the display element when the first gap is between 0 and 10 nm and desaturated colors are reflected from the display element when the first gap is between 150 nm and 250 nm. In some implementations, a height dimension of the first gap and a height dimension of the second gap are synchronously changed. In some implementations of the method, the movable reflector and the movable stack positioned such that the second gap is between about 10 nm and 650 nm and the first gap is at either between about zero (0) nm and 10 nm or between about 100 nm and 200 nm. In other implementations, a height dimension (d1) of the first gap includes changing a voltage across the first electrode and the second electrode, and changing the height dimension (d2) of the second gap includes changing a voltage across the second electrode and the third electrode.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a cross-section of an analog interferometric modulator (AIMOD).

FIG. 10A shows an example of a cross-sectional schematic illustrating certain aspects of an AIMOD having a configuration that includes two moving elements that define a variable first gap (indicated by distance d1) and a variable second gap (indicated by distance d2).

FIG. 10B shows another example of a cross-sectional schematic illustration of an AIMOD utilizing a design including two variable gaps.

FIG. 11 illustrates a CIE 1931 color space chromaticity diagram and an overlying sRGB color space diagram of a simulated color palette produced by an implementation of an AIMOD having a single gap.

FIG. 12 illustrates a CIE 1931 color space chromaticity diagram and an overlying sRGB color space diagram of a simulated color palette produced by an implementation of an AIMOD having a light absorbing, partially transmissive layer and an absorbing matching layer and two gaps.

FIG. 13 is an illustration of light reflecting from and passing through an AIMOD that has one variable gap.

FIG. 14 is an illustration of light reflecting from and passing through an AIMOD having a two variable gap design.

FIGS. 15A-C are chromaticity diagrams illustrating color spirals for simulated AIMODS utilizing both one gap and two gap designs.

FIGS. 16A and 16B illustrate close up views of white portions of images displayed using AIMODS producing the color spirals of FIGS. 15A and 15C.

FIG. 17A illustrates an implementation where a movable absorber layer is fabricated on a supporting dielectric layer.

FIG. 17B illustrates an implementation including a fourth electrode positioned above the movable stack.

FIG. 18 shows an example of a cross-sectional schematic illustration of another implementation of an AIMOD 1800 that includes two variable height gaps.

FIG. 19 shows an example of a cross-sectional schematic illustration of an AIMOD 1900 having two variable gaps and an implementation for changing the height of the gaps.

FIG. 20 also shows an example of a cross-sectional schematic illustration of an AIMOD having two variable gaps and an implementation for changing the height of the gaps.

FIG. 21 shows an example of a flow diagram illustrating a manufacturing process for an AIMOD utilizing a two gap design.

FIGS. 22A-22L show examples of cross-sectional schematic illustrations of various stages in a method of making an analog interferometric modulator that has two gaps.

FIG. 23 shows an example of a flow diagram illustrating a method of displaying information on a display element.

FIGS. 24A and 24B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, an interferometric modulator display element can have one or more movable layers that can be positioned in more than two positions, and such a device can be referred to as an analog interferometric modulator device (AIMOD). Each of the two or more positions causes the AIMOD to reflect light of a different wavelength. In some implementations, an AIMOD can include a dual interferometric gap structure and two absorber layers. Some implementations of an interferometric modulator having two gaps are static configurations, where the height dimensions of the gaps are not variable. Such gaps can include an air gap and/or an optically transmissive material, as part of the gap. In implementations of an AIMOD having two variable gaps, the height dimension of the two gaps can be changed by moving at least one of the layers that define a side of the gap. For example, the AIMOD can include a substrate structure separated from an absorbing layer by a first gap and an absorbing layer separated from a reflective surface of the AIMOD by a second gap. The absorbing layer can be driven to a certain position at a distance d1 from the substrate structure. The reflective layer may also be driven to a certain position at a distance d2 from the absorbing layer, such that the AIMOD reflects a desired color, or appears white or dark (so as to appear, for example, black). The absorbing layer and the reflective layer may be configured to move synchronously relative to the substrate structure's surface to keep the distances d1 and d2 at an optimum distance relationship to produce the desired color. The AIMOD can be configured such that the absorbing layer and the reflective layer are positionable so the distances d1 and d2 take into account that a portion of light incident on a reflective surface can penetrate the reflective surface to a certain depth, the depth based at least in part on the material forming the reflective surface. Accordingly, in determining the distances d1 and d2, such depth penetration can be taken into account. For example, in some implementations, the light penetration depth can be defined by the depth into the reflective surface where a light intensity value is 10% of the light intensity value at the reflective surface itself (that is, where incident light first strikes the reflective surface). Incident light, as used herein, refers to ambient light from the environment in which the display device is used, and also to artificial light that is provided to display elements from a light source of the display device, for example, a front light of the display device. In some implementations where the reflective surface is aluminum, a light intensity drop of 90% corresponds with a penetration depth of about 15 nm. Accordingly, in such implementations, the height of the first gap d1 may be the distance between a substrate structure and the reflective surface+15 nm. Similarly, the second gap d2 can be the distance between the absorbing layer and the reflective surface+15 nm.

Particular implementations of the subject matter described in this disclosure can be implemented to realize one or more of the following potential advantages. An AIMOD having a dual gap structure as described above can provide a color palette that includes more desaturated colors than an AIMOD having a single gap structure. Desaturating the primary colors provided by an AIMOD may include increasing the reflectivity of the AIMOD, such that a reflected primary color is mixed with reflected ambient light, resulting in a desaturation of the primary color. The addition of desaturated colors improves the color smoothness of spatially dithered images.

Interferometric modulators operate at least in part by selective absorption of ambient light. An incident wave at wavelength λ will interfere with its own reflection from the mirror to create a standing wave with local peaks and nulls. For that wavelength, a very thin absorber placed at one of the null positions with respect to a wavelength λ will absorb very little energy, but it will absorb energy of other wavelengths that are not at a null and have higher energy at that position. The distance of the absorber from the reflective surface can be varied to change the wavelengths of light that are absorbed and the wavelength of light that is allowed to pass through the absorbing layer and be reflected from the interferometric modulator.

Saturated primary colors may be used to display non-primary colors using a grayscale method such as amplitude or temporal modulation. If a grey-scale method is not used, saturated colors alone may not provide satisfactorily image quality. For example, spatial dithering with saturated primary colors may not produce images with a smooth appearance. Since at least some images include colors that are not saturated, mixing of saturated colors using spatial dithering may not be able to create a sufficient amount of de-saturated colors. As a result, a spatially dithered image may appear noisy.

Because images reproduced by an imaging device may include desaturated colors, images with an improved visual appearance may be displayed by AIMOD devices that can produce desaturated colors as well as saturated colors. De-saturated colors may be produced by AIMOD devices that include a second gap between a substrate structure and an absorbing layer. The second gap may introduce additional reflections of ambient light such that the primary color being reflected by the AIMOD mixes with reflected ambient light, resulting in reduced saturation of the primary colors.

Accordingly, AIMOD implementations utilizing a dual gap design may provide an increased color palette when compared to IMODs with a single gap architecture by providing desaturated primary colors. Although the implementations of display elements having two gaps disclosed herein are described as being analog interferometric modulators, such features can also be incorporated in implementations of bi-stable interferometric modulator display elements, or display elements having reflectors that can be moved to multiple discrete positions.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and a gap defined between the absorber and the reflector. The reflector can be moved to two or more different positions, which can change the size of the gap and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the gap. One way of changing the gap is by changing the position of the reflector.

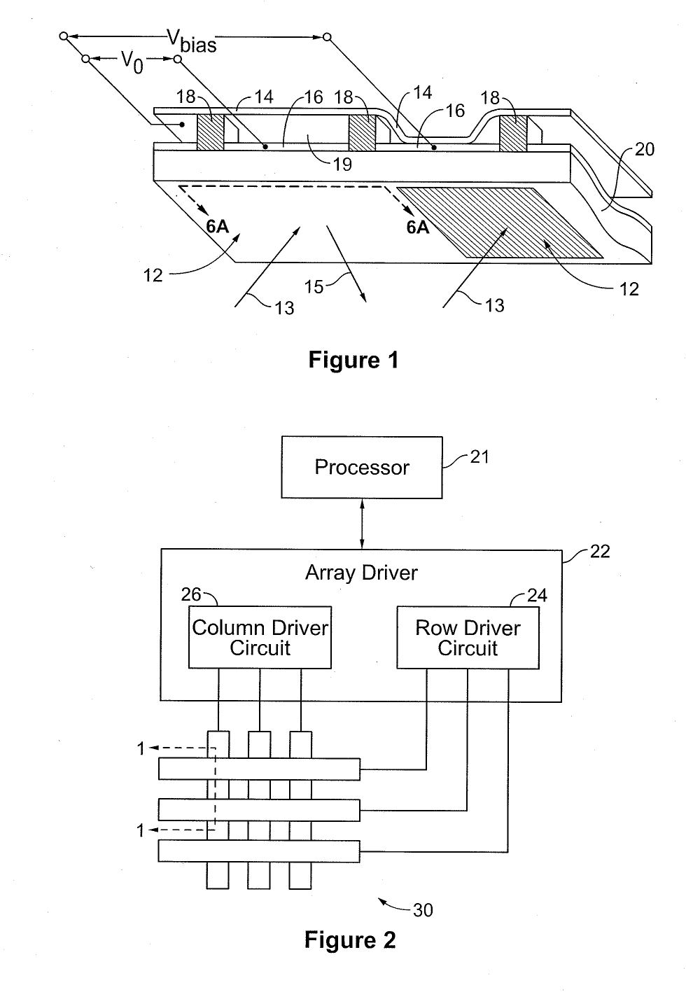

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form a resonant cavity or a gap (also sometimes referred to as an optical cavity or an optical gap). At least a portion of the gap between the fixed partially reflective layer and the movable reflector layer includes an air gap. The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective. In one example, the optical stack 16 may be fabricated by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

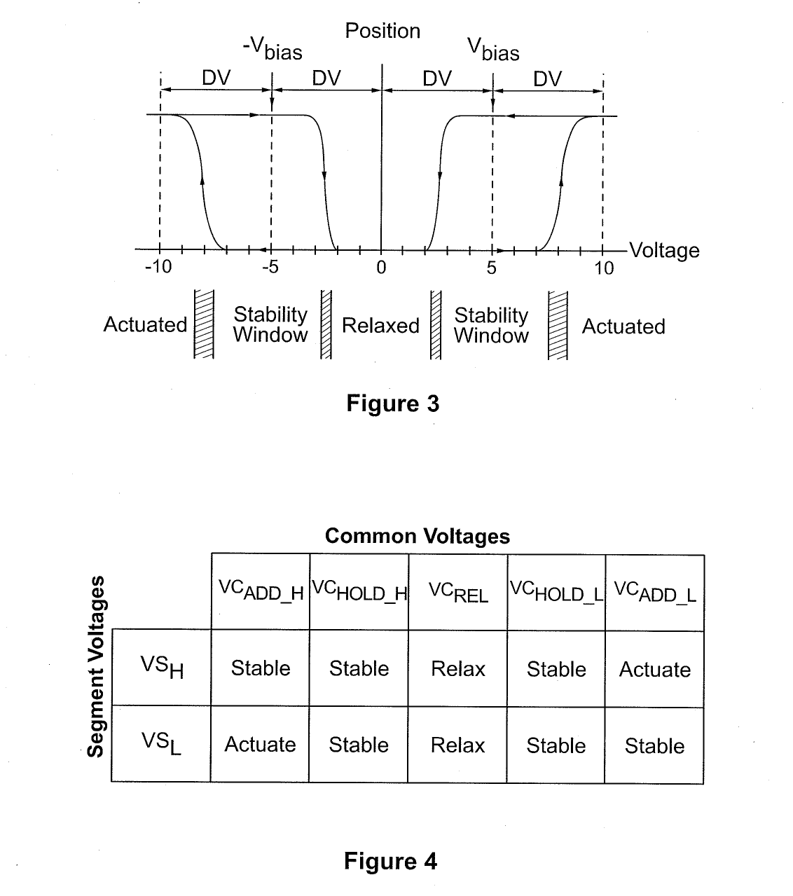

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

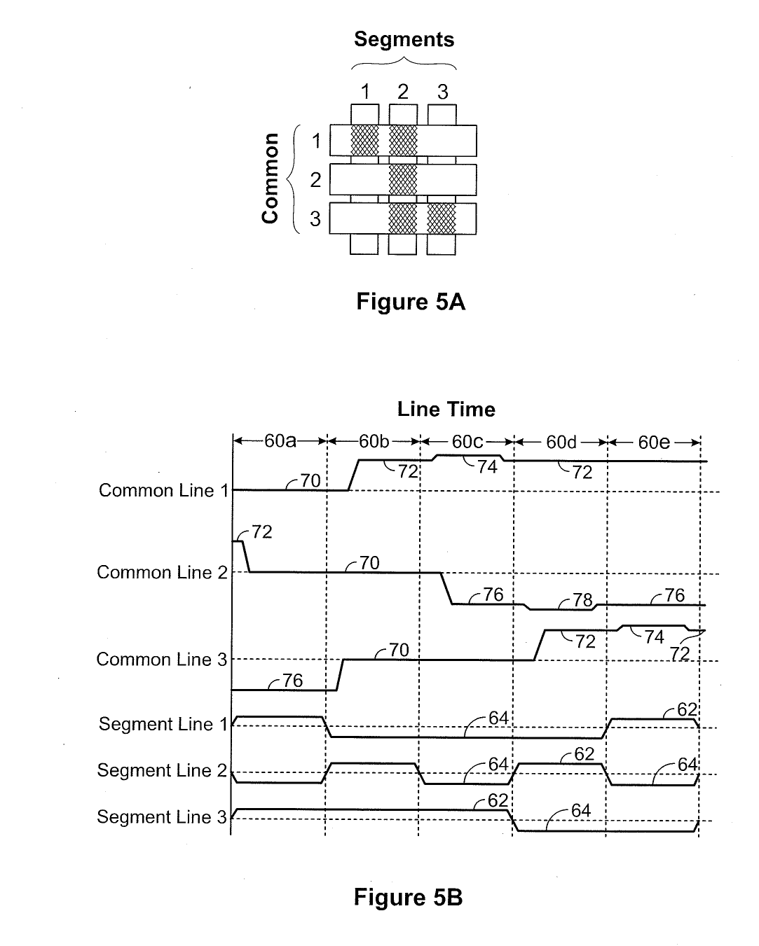

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

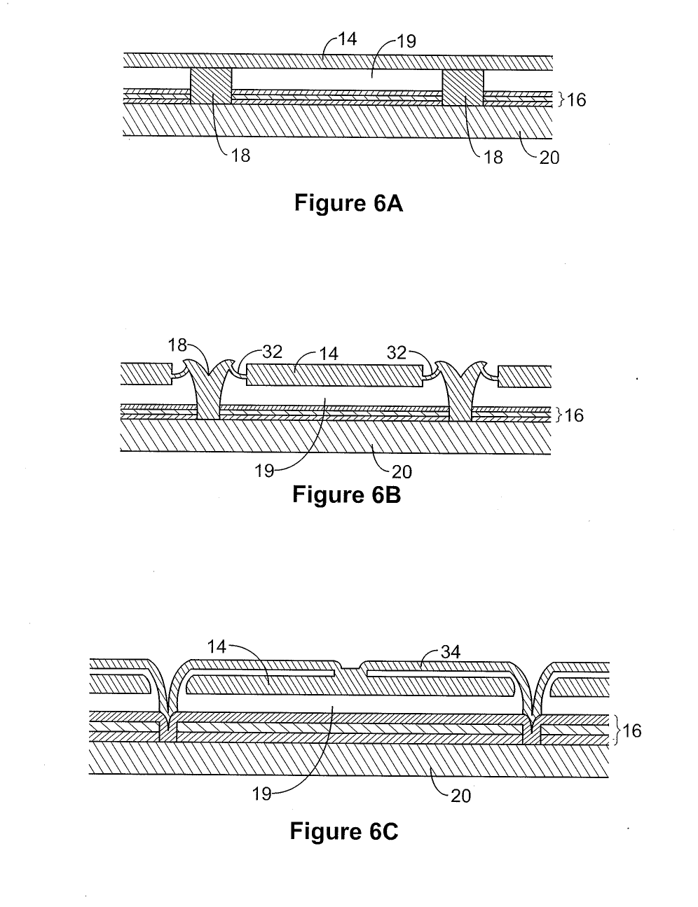

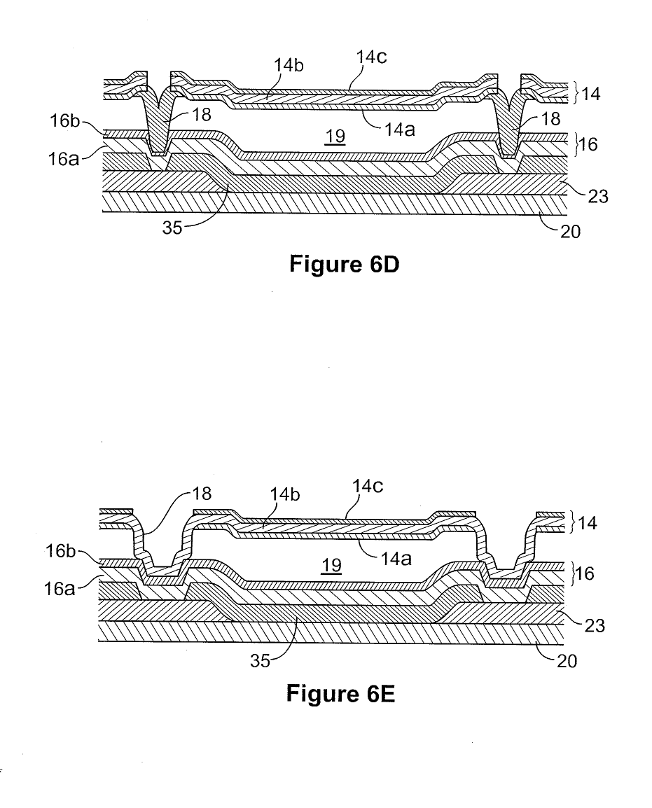

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the molybdenum-chromium (MoCr) and silicon dioxide (SiO₂) layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

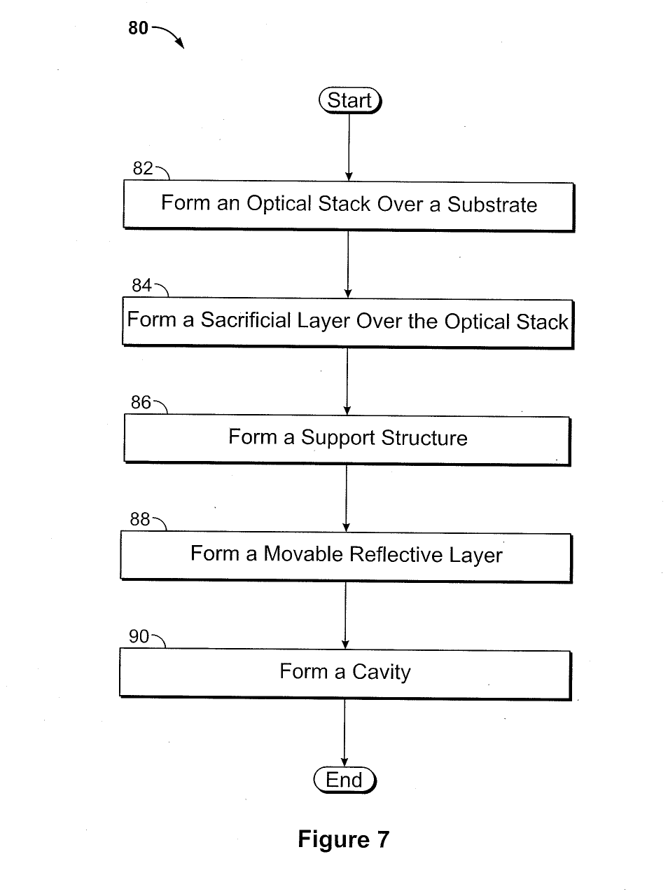

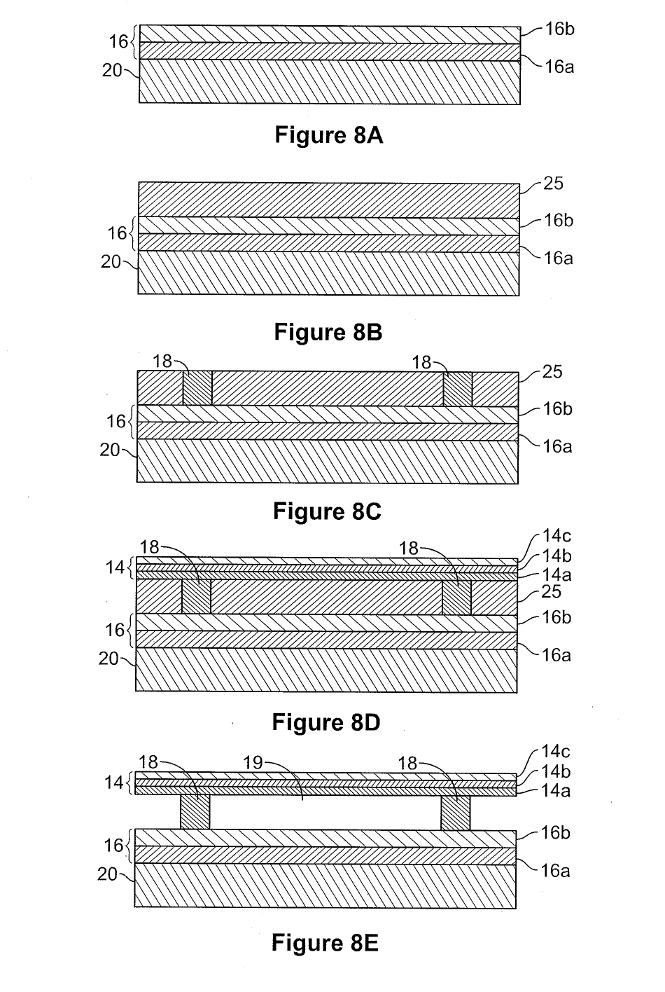

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Another implementation of an electromechanical interferometric modulator is referred to as an analog interferometric modulator, or AIMOD. Many of the features described above relating to bistable IMOD devices are also applicable to AIMODs. However, instead of being a bi-stable device having a movable reflective layer that is positionable in two positions, the movable reflective layer of an AIMOD can be positioned in multiple positions such that the AIMOD can reflect light of many colors, including black or a dark state, based on the position of the movable reflective layer relative to an absorbing layer.

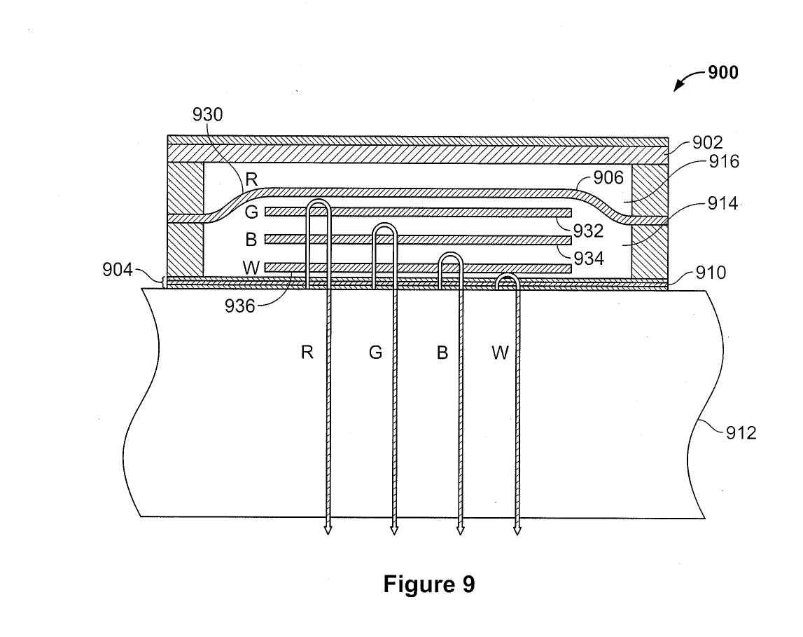

FIG. 9 shows an example of a cross-section of an AIMOD 900. The AIMOD 900 includes a substrate 912 and an optical stack 904 disposed over the substrate 912. The AIMOD 900 also includes a movable reflective layer 906 disposed between a first electrode 910 and a second electrode 902. In some implementations, the optical stack 904 includes an absorbing layer, and/or a plurality of other layers, and can be configured similar to the optical stack 16 illustrated in FIGS. 1, 6A-6E. In some implementations, and in the example illustrated in FIG. 9, the optical stack 904 includes the first electrode 910 which is configured as an absorbing layer. In some implementations, the absorbing layer first electrode 910 can be a 6 nm layer of material that includes MoCr.

Still referring to FIG. 9, the reflective layer 906 can be provided with a charge. The reflective layer is configured to, once charged, move toward either the first electrode 910 or the second electrode 902 when a voltage is applied between the first and second electrodes 910 and 902. In this manner, the reflective layer 906 can be driven through a range of positions between the two electrodes 902 and 910, including above and below a relaxed (unactuated) state. For example, FIG. 9 illustrates the reflective layer 906 can be moved to various positions 930, 932, 934 and 936 between the upper electrode 902 and the lower electrode 910.

The AIMOD 900 can be configured to selectively reflect certain wavelengths of light depending on the configuration of the modulator. The distance between the lower electrode 910, which in this implementation acts as an absorbing layer, and the reflective layer 906 changes the reflective properties of the AIMOD 900. Any particular wavelength is maximally reflected from the AIMOD 900 when the distance between the reflective layer 906 and the absorbing layer first electrode 910 is such that the absorbing layer (first electrode 910) is located at the minimum light intensity of standing waves resulting from interference between incident light and light reflected from the reflective layer 906. For example, as illustrated, the AIMOD 900 is designed to be viewed on the substrate 912 side of the modulator (through the substrate 912). Light enters the AIMOD 900 through the substrate 912. Depending on the position of the reflective layer 906, different wavelengths of light are reflected back through the substrate 912, which gives the appearance of different colors. These different colors are also known as native colors. A position of a movable layer(s) of a display element (e.g., an interferometric modulator) at a location such that it reflects a certain wavelength or wavelengths can be referred to a display state. For example, when the reflective layer 906 is in position 930, red wavelengths of light are reflected in greater proportion than other wavelengths and the other wavelengths of light are absorbed in greater proportion than red. Accordingly, the AIMOD 900 appears red and is said to be in a red display state, or simply a red state. Similarly, the AIMOD 900 is in a green display state (or green state) when the reflective layer 906 moves to position 932, where green wavelengths of light are reflected in greater proportion than other wavelengths and the other wavelengths of light are absorbed in greater proportion than green. When the reflective layer 906 moves to position 934, the AIMOD 900 is in a blue display state (or blue state) and blue wavelengths of light are reflected in greater proportion than other wavelengths and the other wavelengths of light are absorbed in greater proportion than blue. When the reflective layer 906 moves to a position 936, the AIMOD 900 is in a white display state (or white state) and a broad range of wavelengths of light in the visible spectrum are reflected such that and the AIMOD 900 appears “white” or “silver.”It should be noted that the AIMOD 900 can be in different states and selectively reflect other colors of light (or other spectrums of wavelengths) based on the position of the reflective layer 906, and also based on materials that are used in construction of the AIMOD 900, particularly various layers in the 904.

The AIMOD 900 in FIG. 9 has two structural gaps, a first gap 914 between the reflective layer 906 and the optical stack 904, and a second gap 916 between the reflective layer 906 and the second electrode 902. However, because the reflective layer 906 is reflective and not transmissive, light does not propagate through the reflective layer 906 into the second gap 916. In other words, the second gap provides space allowing reflective layer 906 to move but the gap itself has no optical effect. In addition, the color and/or intensity of light reflected by the interferometric modulator 906 is determined by the distance between the reflective layer 906 and the absorbing layer (first electrode 910). Accordingly, the AIMOD 900 illustrated in FIG. 9 has one interferometric gap 914.

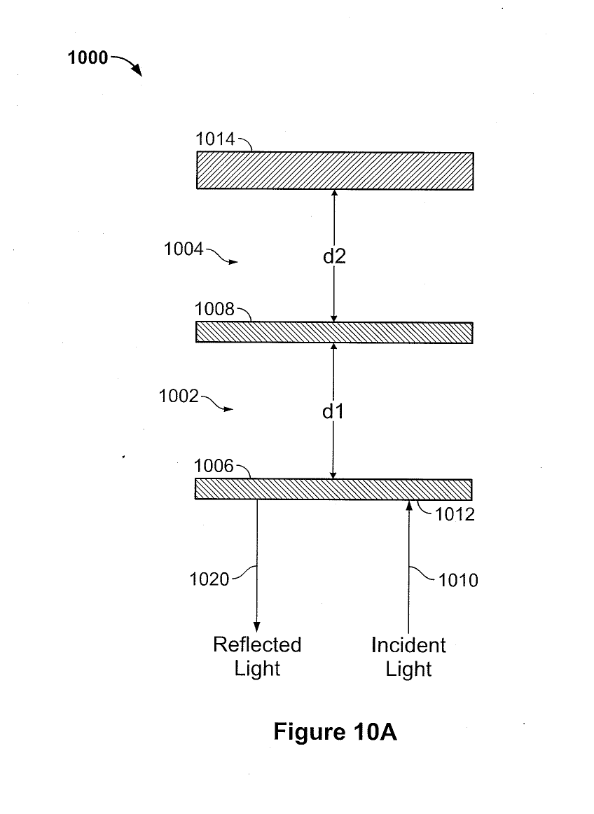

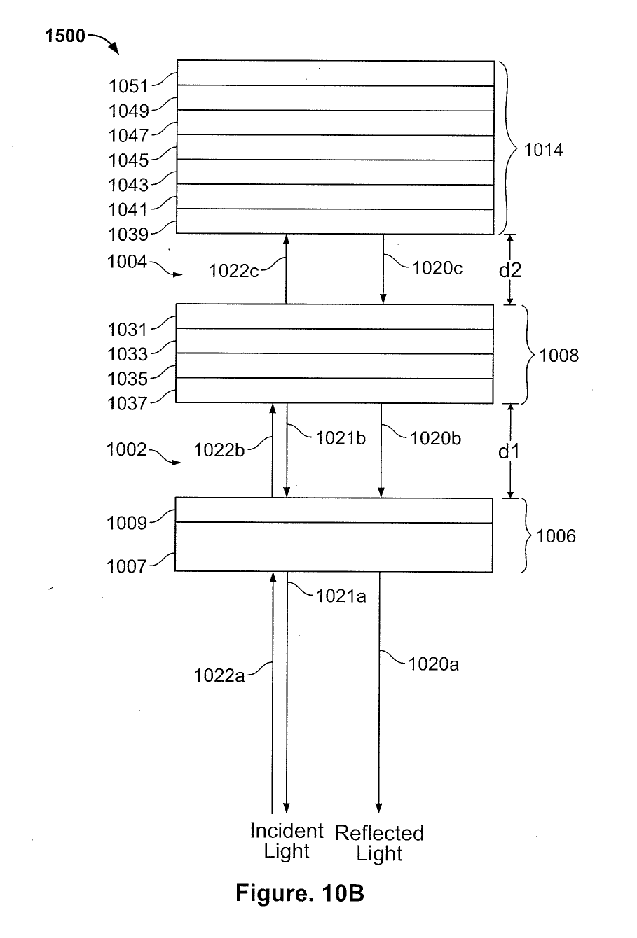

FIG. 10A shows an example of a cross-sectional schematic illustrating certain aspects of an AIMOD 1000 having a configuration that includes two moving elements that define a variable first gap 1002 (indicated by distance d1) and a variable second gap 1004 (indicated by distance d2). AIMOD 1000 includes a stationary substrate structure 1006, a movable reflector 1014 and an absorber 1008 positioned between the substrate structure 1006 and the movable reflector 1014. For clarity of this illustration, FIG. 10A does not show all of the elements of AIMOD 1000, for example, supporting structure, individual conductive driving layers, connections to driving circuits and other layers that may be included in the illustrated elements. For example, in various implementations the absorber 1008, the reflector 1014 and the substrate structure 1006 can include a conductive layer that is connected to a driving circuit. The movable absorber 1008 can include a stack of two or more layers, and/or the substrate structure 1006 and the reflector 1014 can also include two or more layers, for example, as shown in the implementation illustrated in FIG. 10B. Absorbers including a stack of two or more layers may be referred to as a movable stack. In FIG. 10A, the variable first gap 1002 is defined between the substrate structure 1006 and the movable absorber 1008, and the variable second gap 1004 is defined between the movable absorber 1008 and the movable reflector 1014.

Still referring to FIG. 10A, the substrate structure 1006, the absorber 1008, and the reflector 1014 are conductive, each including one or more conductive layers that may be connected to a driving circuit of the AIMOD 1000. The AIMOD 1000 is configured to move the absorber 1008 to different positions relative to the substrate structure 1006 (changing the distance d1 of the first gap 1002) and move the reflector 1014 to different positions relative to the absorber 1008 (changing the distance d2 of the second gap 1004) using electrostatic forces by applying various voltages across the substrate structure 1006 and the absorber 1008, and between the absorber 1008 and the reflector 1014, respectively. The second gap 1004 of the AIMOD 1000 is an interferometric cavity which can operate in accordance with the optical principles described at least with reference to FIGS. 1 and 9. The second gap (interferometric cavity) 1004, the reflector 1014 and the absorber 1008 operate to produce a plurality of colors of reflected light. The absorber 1008, in addition to being absorptive of light of certain wavelengths depending on its position relative to the light reflecting from the reflector 1014, is partially transmissive and partially reflective. The interaction of light propagating through the substrate structure 1006, entering the first gap 1002, and being incident on the absorber 1008 causes some of the light to reflect back out of the AIMOD 1000 without having entered the second gap 1004, and this reflected light may be approximately the same color as the light entering the AIMOD 1000. That is, under daylight conditions with generally “white” light (visible light having a broad spectrum of wavelengths indicative of the incident light) this reflected light may also be approximately white. The reflection of this “white” light (that never passes through the absorber 1008) can be due to reflections from the one or more layers of the substrate structure 1006 and the one or more layers of the absorber 1008, and the distance d1 of the first gap 1002. Accordingly, selecting different materials and thicknesses of the one or more layers of the substrate structure 1006 and the one or more layers of the absorber 1008, and different distances d1 of the first gap 1002 all can affect the amount of light that is reflected. The spectrum of the reflected light may also deviate slightly from the typical D65 spectrum of incident light.

AIMOD 1000 can be operated to reflect certain wavelength spectrums to correspondingly produce a certain set of reflected colors as controlled by positioning the reflector 1014 relative to the absorber 1008, and varying the second gap 1004. Additionally, AIMOD 1000 can be operated to affect the saturation of the light reflected by the AIMOD 1000 by positioning the absorber 1008 relative to the substrate structure 1006 varying the first gap 1002. In some implementations, the absorber 1008 is placed at one of two positions (that is, at two different distances d1) relative to the substrate structure 1006 to affect the saturation of reflected light. In such implementations, one of the two positions may minimize the reflection of light incident (or white) and be used for generating saturated colors, and the other position may be selected to produce a desired reflection of incident light to produce less saturated (or desaturated) colors from the AIMOD 1000.

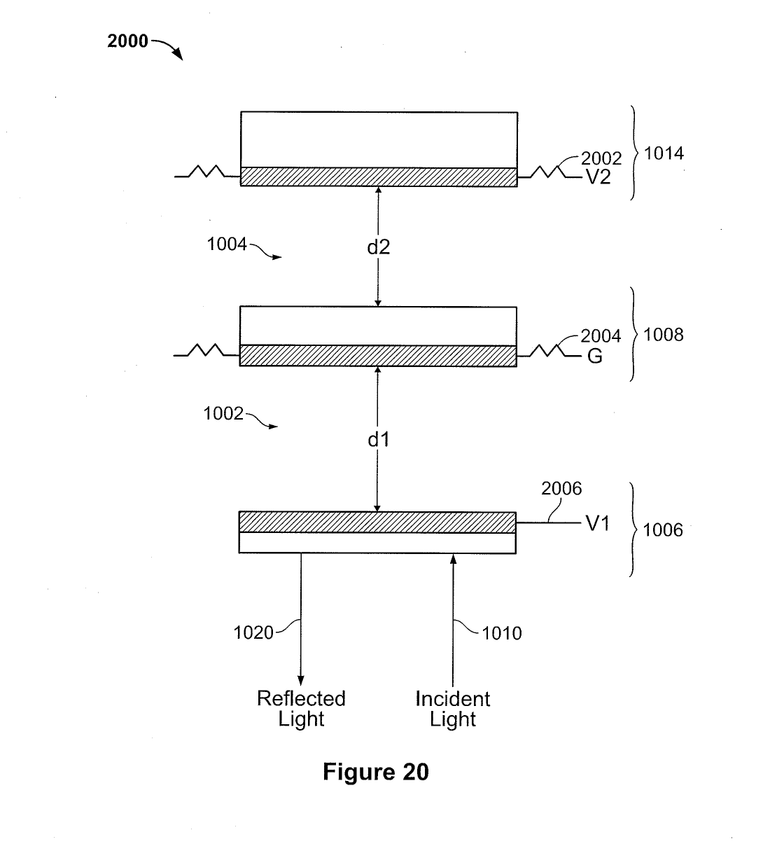

Such implementations may provide twice as many possible colors of reflected light 1020, or native colors. In some implementations, the AIMOD 1000 can be configured to move the absorber 1008 such that the first gap 1002 distance d1 is at one of two distances, the first distance being between 0 nm and 10 nm, and the second distance being between 100 nm and 200 nm. In such implementations, saturated colors may be produced from the AIMOD 1000 when the absorber 1008 is positioned to define the first gap between 0 nm and 10 nm (causing less, or a minimum, reflection of incident light), and desaturated colors may be produced when the absorber 1008 is positioned to define the first gap between 100 nm and 200 nm (causing more, or maximum, reflection of incident light). As discussed later in reference to FIG. 20, AIMODs can be fabricated similar to the fabrication processes described in reference to FIGS. 7 and 8A-8E but where two gaps are formed using two sacrificial layers.

FIG. 10B shows another implementation of a cross-sectional schematic illustration of an AIMOD 1500 that includes two variable gaps. Like the AIMOD 1000 illustrated in FIG. 10A, AIMOD 1500 can also include a stationary substrate structure 1006, a movable absorber 1008, and a movable reflector 1014. However, the implementation of AIMOD 1500 illustrated in FIG. 10B includes more details of two or more layers that can form each of the substrate structure 1006, a movable absorber 1008, and a movable reflector 1014. The layers and materials described and illustrated for AIMOD 1500 can be used in any of the implementations described herein.

The AIMOD 1500 includes a variable first gap 1002, defined between the substrate structure 1006 and the movable absorber 1008, the height of the first gap 1002 indicated by distance d1. The AIMOD 1500 also includes a variable second gap 1004, defined between the movable absorber 1008 and the movable reflector 1014, the height of the second gap 1004 indicated by distance d2.

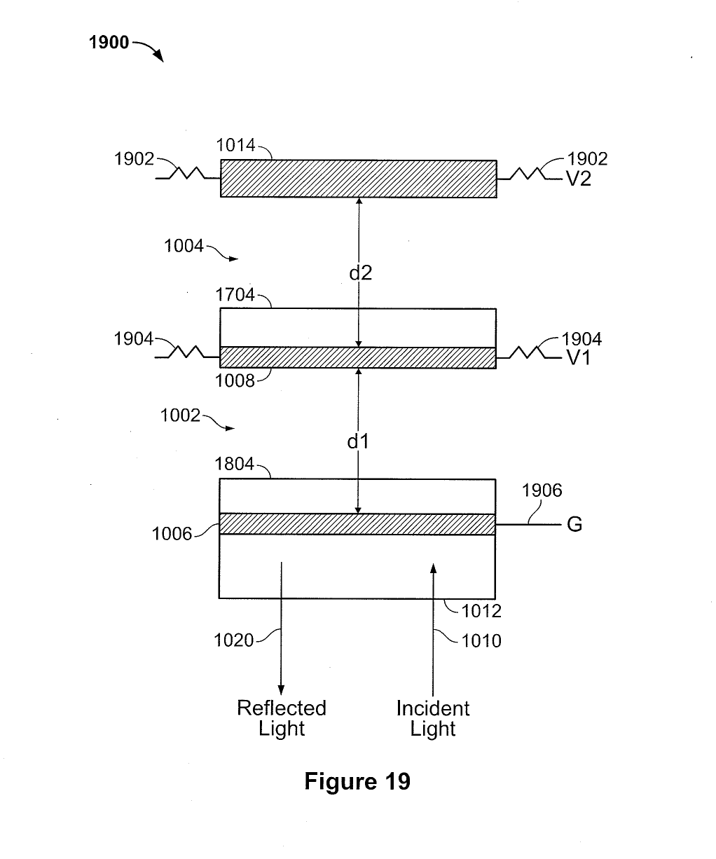

Still referring to FIG. 10B, the substrate structure 1006 can include a substrate 1007, and include a transmissive conductive layer 1009 which can be connected to a driving circuit and operate as a driving electrode to position the movable absorber 1008 and/or the movable reflector relative to the substrate structure 1006 using electrostatic forces. The conductive layer 1009 may have a thickness of between about 3 nm and about 15 nm in the optically active area of the AIMOD 1500. In some implementations the conductive layer 1009 can be indium tin oxide (ITO). In one example, the thickness of the conductive layer 1009 can be 5 nm. In some implementations, the substrate 1007 may be comprised of silicon dioxide (SiO₂). A portion of the substrate structure 1006 may be configured as an electrode and used to drive movable layers of the AIMOD 1500 (as described in reference to FIGS. 19 and 20). For example, the conductive layer 1009 may be connected to a driving circuit and operate as a driving electrode to position the movable absorber 1008 and/or the movable reflector relative to the substrate structure 1006 using electrostatic forces.

Still referring to FIG. 10B, the absorber 1008 may be partially transmissive and partially absorptive of light. The absorber 1008 may also include multiple layers, and may be referred to as being a film stack. For example, some implementations of the absorber include an aluminum oxide (AlO₃) layer 1031 and a vanadium (V) layer 1033. Some implementations of the absorber 1008 may also include a layer of silicon dioxide (SiO₂) 1035. Some implementations may also include a layer of silicon nitride (Si₃N₄) 1037. In some implementations, absorber 1008 includes a layer of molybdenum-chromium (MoCr) that has a thickness dimension in an active area of the AIMOD of between about 4 nm and about 6 nm. As illustrated in the implementation of FIG. 10B, the multiple layers of the absorber 1008 film stack can be layered in order of silicon nitride (Si₃N₄) 1037, silicon dioxide (SiO₂) 1035, vanadium (V) layer 1033 and aluminum oxide (AlO₃) layer 1031 where the silicon nitride (Si₃N₄) 1037 layer is disposed closest to the substrate structure 1006.

The absorbing layer described herein can be configured as an electrode and used to drive movable layers of the AIMOD, for example as described in reference to FIGS. 19 and 20. For example, the vanadium layer 1033 may function as an electrode in some implementations.

The position of the absorber 1008 relative to the reflector 1014 defines the second gap 1004 (and distance d2) discussed above and defines wavelengths of light that are absorbed by the absorber 1008 (sometimes referred to as “interferometric absorption”), as previously described in reference to the AIMOD illustrated in FIG. 9. In some implementations, the movable absorber 1008 can be placed at two or more positions including against the substrate structure 1006 or at a distance from the substrate structure 1006.

Still referring to FIG. 10B, the reflector 1014 can also include multiple layers. For example, the reflector 1014 may include a reflective surface that includes layers of titanium dioxide (TiO₂) 1039, silicon oxynitride (SiON) 1041, and aluminum (Al) 1043. In some implementations the aluminum layer 1043 may be between 35 nm and 50 nm in thickness. The aluminum layer 1043 may also be connected to a driving circuit (FIG. 2) and operate as a driving electrode to move the reflector 1014 using electrostatic forces. In some implementations, the layer of silicon oxynitride 1041 may be between 65 nm and 80 nm in thickness. The reflector 1014 may also include a titanium dioxide (TiO₂) layer 1039. As illustrated in this implementation, the TiO₂ layer 1039 of the reflector 1014 can be disposed proximal to the absorber 1008. In some implementations, the TiO₂ layer 1039 can be between about 20 and 40 nm in thickness.

The reflective surface of the reflector may be configured such that the reflected light 1020a-c from the AIMOD 1500 can be, for example, at least light having a wavelength(s) in the range of visible light, for example, wavelengths between about 390 nm and about 750 nm.

The reflective surface comprised of layers 1039, 1041 and 1043 may be mounted to a support structure 1045, which may also be comprised of silicon oxynitride (SiON) to provide structural rigidity. The support structure can be transparent, semi-transparent, or non-transparent because in the illustrated implementation the AIMOD 1500 is not configured to receive incident light through the support structure 1045. The reflector 1014 may also include additional layers, for example, a layer of titanium dioxide (TiO₂) 1051, a layer of silicon oxynitride (SiON) 1049 and a layer of aluminum (Al) 1047. These layers may form a symmetrical structure about the mechanical layer 1045.

Still referring to FIG. 10B, incident light 1022a can enter the AIMOD 1500 through the substrate structure 1006, which can be substantially transparent to visible light. The incident light 1022b then can exit the substrate structure 1006 and enter the first gap 1002. After propagating through the first gap 1002, the incident light 1022b contacts the absorber 1008. A portion of light 1022b is reflected by the surface of the absorber 1008 as reflected light 1021b. A portion of light 1022b may also penetrate the surface of absorber 1008 and interact with layers 1031, 1033, 1035, and 1037 before being reflected as light 1021b. The light 1021b passes back out of the AIMOD 1500 through substrate structure 1006 as reflected light 1021a. Another portion of incident light 1022b passes through the absorber 1008 as light 1022c. After passing through the absorber 1008, the incident light 1022c then passes through interferometric second gap 1004.

As described above, the second gap 1004 is variable, that is, the second gap 1004 can be changed to various heights. For example, the reflector 1014 may be driven to vary its position with respect to the absorber 1008. Alternatively, the movable absorber 1008 may be driven to vary its position with respect to the movable reflector 1014. One or both of these movements may change the height dimension d2 of the second gap 1004. After incident light 1022c passes through the second gap 1004, the light is incident on movable reflector 1014.

After being reflected by the movable reflector 1014, the reflected light 1020c passes back through the (interferometric) second gap 1004. Reflected light 1020b then passes through the absorber 1008. Depending on the position of the absorber 1008 with respect to the movable reflector 1014, some wavelengths of light may be at least partially absorbed by the absorber 1008. Other wavelengths of light may pass through the absorber and experience less absorption. Finally, the wavelengths of reflected light not absorbed by the absorber 1008 pass through the substrate structure 1006 indicated by light 1020a.

As described for the AIMOD 1000 in FIG. 10A, the AIMOD 1500 is configured such that the absorber 1008 is selectively positioned at either two positions each a different distance from the substrate structure 1006, defining the first gap 1002 at one of two distance dimensions. In some implementations, the first position is at a first distance between 0 nm and 10 nm, and the second position is at a second distance between 100 nm and 200 nm. The first position may be used for generating saturated colors and the second position may be used for generating desaturated colors. That is, when the AIMOD 1500 is driven to place the absorber 1008 at one of these two positions, the color of light reflected by the AIMOD 1500 is more saturated at the first position and less saturated at the second position. Accordingly, by utilizing a display element configuration having two gaps, such an AIMOD 1000 and 1500, and AIMOD can provide both saturated and desaturated primary colors. In some implementations, saturated colors may be produced when the AIMOD is configured with a first gap of between 0 nm and 10 nm, and desaturated primary colors may be produced when the first gap is configured to be between 100 nm and 200 nm. As discussed later in reference to FIG. 20, AIMODs can be fabricated similar to the fabrication processes described in reference to FIGS. 7 and 8A-8E but where two gaps are formed using two sacrificial layers.

The function of the pair of high and low refractive index films (e.g., 1037 of Si₃N₄ and 1035 of SiO₂) in the absorber assembly 1008 is to minimize the spurious reflection such that the color reflected from the AIMOD is saturated when the second gap 1004 is at the first position of between 0 nm and 10 nm.

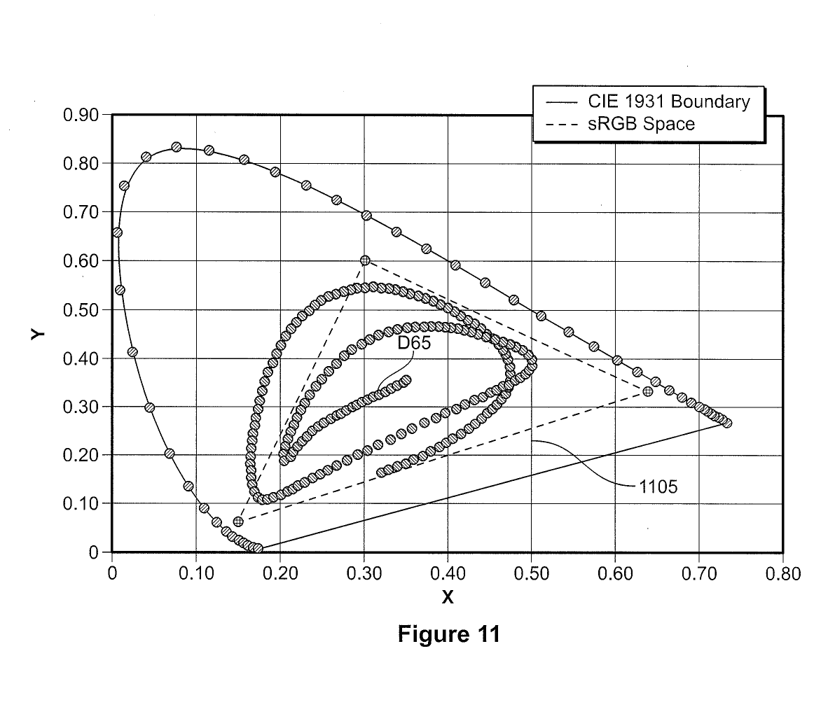

FIG. 11 illustrates a CIE 1931 color space chromaticity diagram and an overlying sRGB color space diagram of a simulated color palette produced by an implementation of an AIMOD having a single gap. D65 indicates a white point that is the CIE Standard Illuminant D65 correlate to 6504K color temperature. The diagram also includes an overlying gamut of sRGB color space.

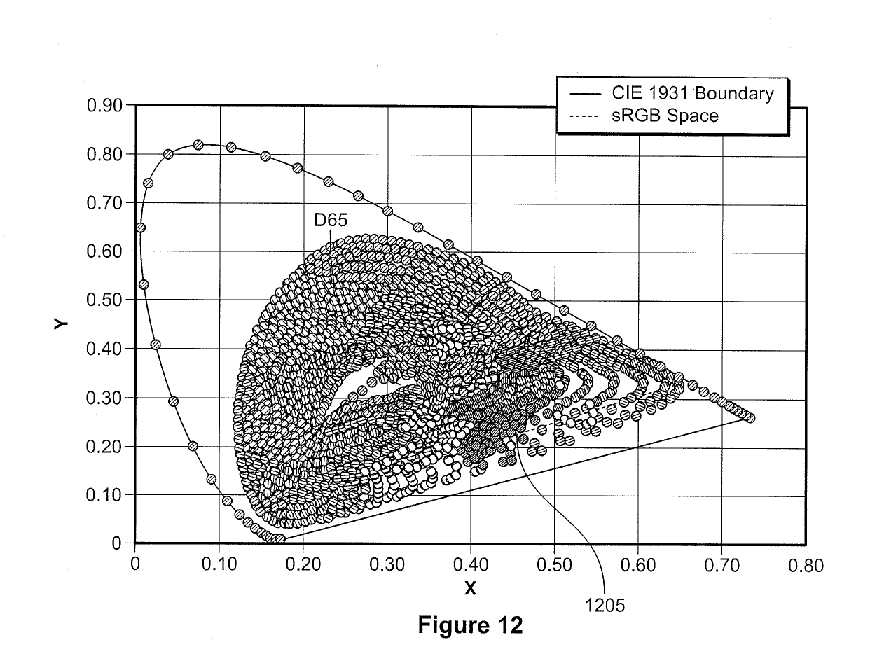

FIG. 12 illustrates a CIE 1931 color space chromaticity diagram and an overlying sRGB color space diagram of a simulated color palette produced by an implementation of an AIMOD having a light absorbing, partially transmissive layer and an absorbing matching layer and two gaps. The diagram also includes an overlying gamut of sRGB color space. The color spiral illustrated in FIG. 11 was simulated with a single air gap (an interferometric cavity) of a height dimension between the reflector and the absorber stepped from 0 nm to 650 nm. The color spiral illustrated in FIG. 12 was simulated with two air gaps, configured similarly to the implementations shown in FIGS. 10A and 10B. The first gap 1002 distance d1 was incremented from 0 to 50 with steps of 5 nm, and with steps of 10 nm from 50 to 100 nm. The second gap 1004 distance d2 was changed from 10 nm to 650 nm with a 2.5 nm step for each step.

The simulated values illustrated in FIG. 12 cover a larger area of the CIE color space than do those values illustrated in FIG. 11. By varying the first gap 1002 of the AIMODS of FIG. 10A or 10B, these AIMODS can efficiently shift and alter the color spiral created by the tuning of gap d2. The shifted spirals overlap in FIG. 12 and fill a larger portion of the area bounded by the RGB triangle 1205, which is only partially visible. The overlapping regions indicate colors having the same xy chromaticity value but different luminance. This difference in luminance may provide an opportunity to reduce the need for temporal modulation of images displayed using the disclosed AIMODs. This may improve the brightness or the resolution of an AIMOD display when compared to AIMOD displays that utilize a pixel grey-scaling method such as temporal modulation. Electric power consumption associated with the implementation of temporal modulation may also be reduced.

In summary, significant improvement in the coverage of the color gamut is shown in FIG. 12. The AIMOD generating the results of FIG. 12 implements two gaps (for example, the first gap 1002 and the second gap 1004 illustrated in FIGS. 10A and 10B) and includes a light absorbing partially transmissive layer and a substantially transparent substrate structure 1006. The color palette of the disclosed AIMOD compares favorably to an AIMOD with only one gap (for example, AIMOD 900 of FIG. 9) separating a reflector and an absorber. FIGS. 11 and 12 show that an AIMOD having two variable gaps is capable of producing colors with varying luminance and similar xy chromaticity values. The varying luminance for a given broadband spectrum of incident light produced by a dual gap AIMOD may reduce the need for temporal modulation of colors. Accordingly, using a dual gap design can provide additional primary colors with varied desaturation and luminance when compared to a single gap design.

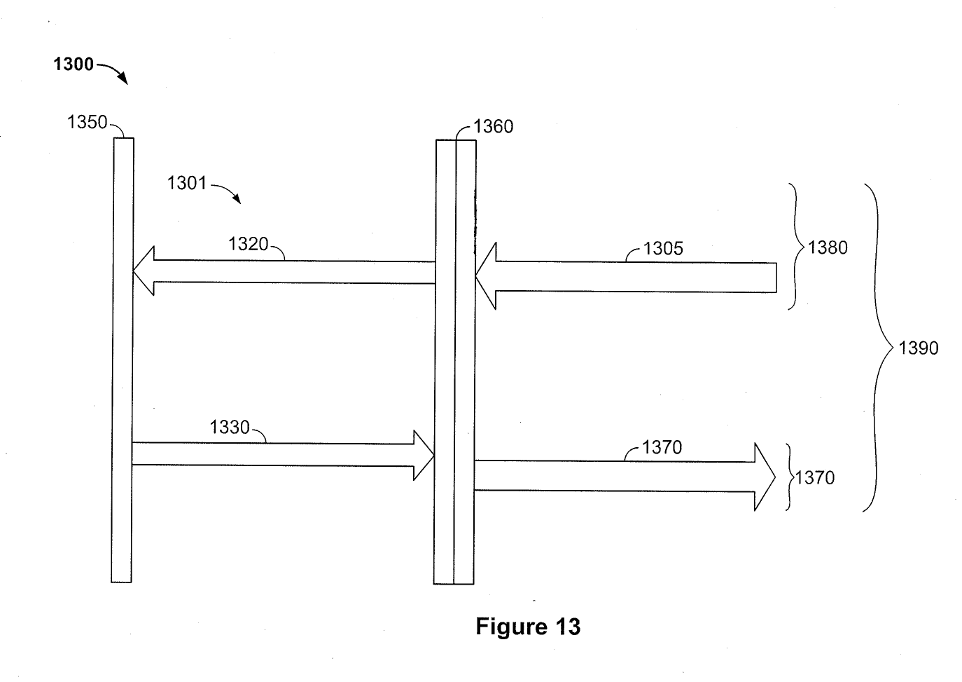

FIG. 13 is an illustration of light reflecting from and passing through an AIMOD 1300 that has one variable gap. The one variable gap 1301 is between an absorbing layer 1360 and a reflector 1350, and gap 1301 is an interferometric cavity. Incident light 1305 contacts the absorbing layer 1360. In implementations such as the one illustrated in FIG. 9, the absorbing layer 1360 is stationary and disposed on a substrate, and only a small amount of light is reflected by the absorbing layer 1360. A portion of the incident light passes through the absorbing layer 1360 as incident light 1320. Incident light 1320 contacts the reflector 1350 and is reflected as reflected light 1330. Depending on the position of the absorbing layer 1360 relative to the reflector 1350, certain wavelengths of reflected light 1330 may be absorbed by the absorbing layer 1360. Some portion of light 1330 may also be reflected back by absorbing layer 1360 towards the reflector 1350 and then further reflected by reflector 1350 (this reflection is not shown in the figure). Some portion of the reflected light may pass through the absorbing layer 1360 as reflected light 1370.

In the example of FIG. 13, light reflected from the AIMOD 1390 includes the light 1370, which includes wavelengths of light that were not absorbed when they passed through absorbing layer 1360. In an embodiment, absorbing layer 1360 may include absorbing matching layers such as those illustrated as layers 1035 and 1037 in FIG. 10B).

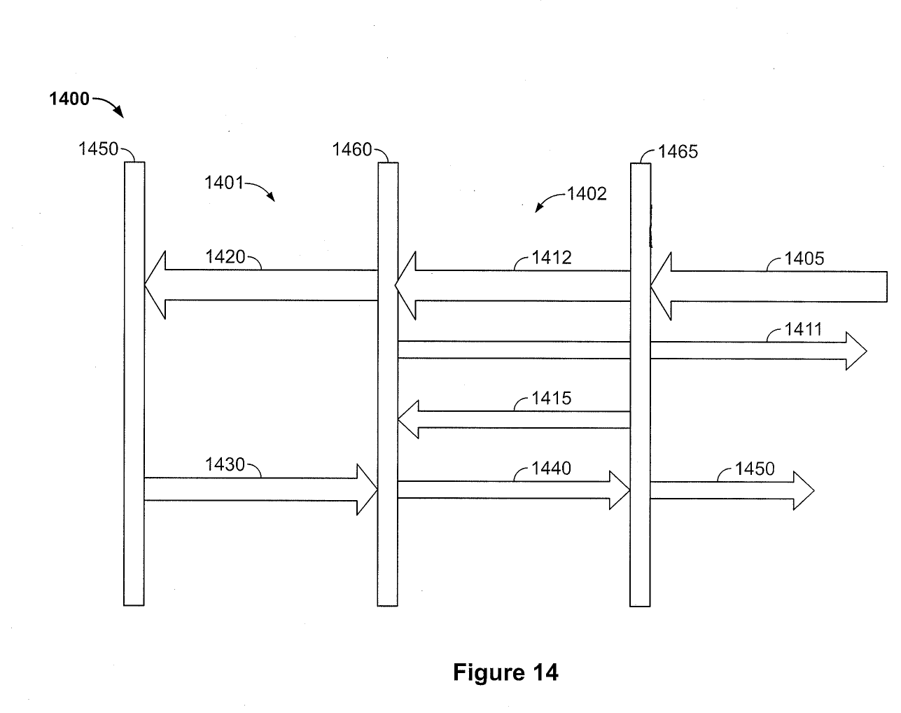

FIG. 14 is an illustration of light reflecting from and passing through an AIMOD device 1400 having a two variable gap design. The AIMOD device 1400 includes a first gap 1402 positioned between a movable absorbing layer 1460 and a substantially transparent substrate structure 1465. The absorbing layer 1460 can be a structure that includes multiple layers (that is, a film stack). A second gap 1401 is positioned between a movable reflector 1450 and the absorbing layer 1460.

Incident light 1405 enters the AIMOD device 1400 through the substrate structure 1465. A portion of the incident light 1405 is reflected by the surface of the substrate structure. In some implementations, the percent of incident light 1405 reflected by the surface of the substrate structure may be less than one percent of the incident light. For example, an implementation may utilize an anti-reflection coating on the substrate structure to reduce the amount of light reflected by the surface of substrate structure 1465. The incident light 1405 that is not reflected by the surface of the substrate structure 1465, indicated as light 1412, passes through the substrate structure 1465 and into the first gap 1402. Upon contacting the absorbing layer 1460, a portion of the light 1412 is reflected by the absorbing layer 1460 as reflected light 1411. A portion of reflected light 1411 may be further reflected by the substrate 1465 back towards the absorbing layer 1460, and further reflected by the surface of the absorbing layer 1460 again. This pattern of further reflection is not shown in FIG. 14 for clarity. Accordingly, light entering the AIMOD device 1400 may experience one or more reflections between layers 1460 and 1465

The portion of light 1412 not reflected by the absorbing layer 1460 propagates through the absorbing layer 1460 as light 1420. Propagating light 1420 then is incident on the movable reflector 1450 and is reflected as reflected light 1430. Depending on the position of the absorbing layer 1460 relative to the movable reflector 1450, a portion of the wavelengths of reflected light 1430 will be absorbed by the absorbing layer 1460. Another portion of the wavelengths of reflected light 1430 may be reflected back by layer 1460 towards the movable reflector 1450 and be further reflected by the movable reflector 1450 for a second time. This pattern of reflection is also not shown in the figure for clarity. An additional portion of reflected light 1430 may pass through the absorbing layer 1460 and the substrate structure 1465 to exit the AIMOD device 1400. Therefore, light entering the AIMOD 1400 may experience one or more reflections from layer 1450 and then pass through the absorbing layer 1460 as reflected light 1440. The illustrated thinner width of reflected light 1440 in FIG. 14, as compared to reflected light 1430 represents a reduced set of light wavelengths in reflected light 1440 when compared to reflected light 1430. Most of the reflected light 1440 passes through the substantially transparent substrate structure 1465. A small portion of light 1440 may be reflected by substrate 1465 towards absorbing layer 1460 and experience additional reflections.

The light reflected by AIMOD 1400 and perceived by a viewer includes the coherent summation of light 1411 and 1450. Gap 1402 reduces the saturation of colors produced by AIMOD 1400 when compared to the single gap design shown in FIG. 13. With AIMOD 1400, there is more ambient light present in AIMOD 1400's reflected light spectrum when compared with AIMOD 1300's light spectrum as shown in FIG. 13. Consequently, light reflected from AIMOD 1400 may appear to be more desaturated than the colors reflected from AIMOD 1300. The degrees of desaturation may be controlled by the size of gap 1402.

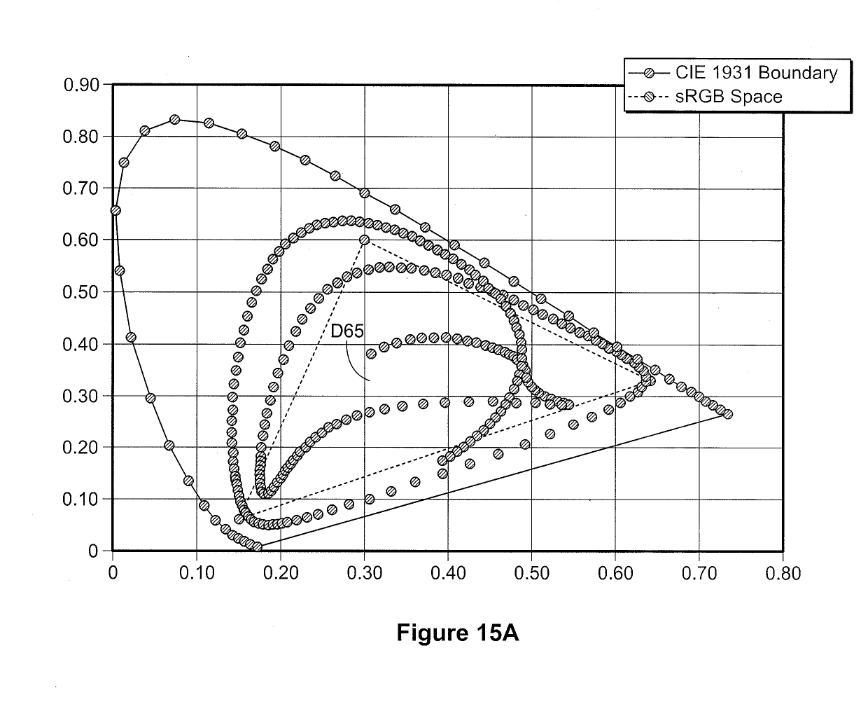

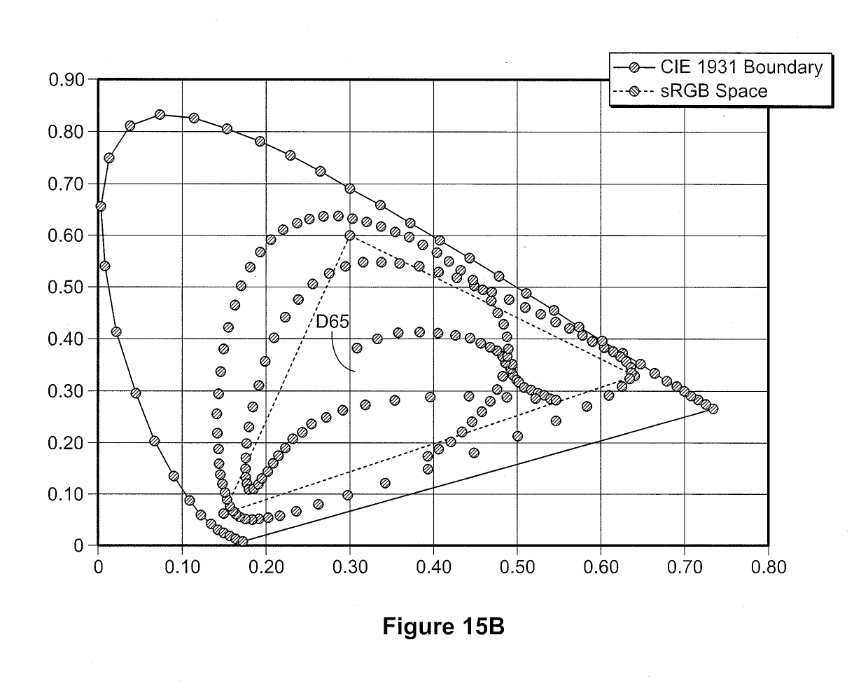

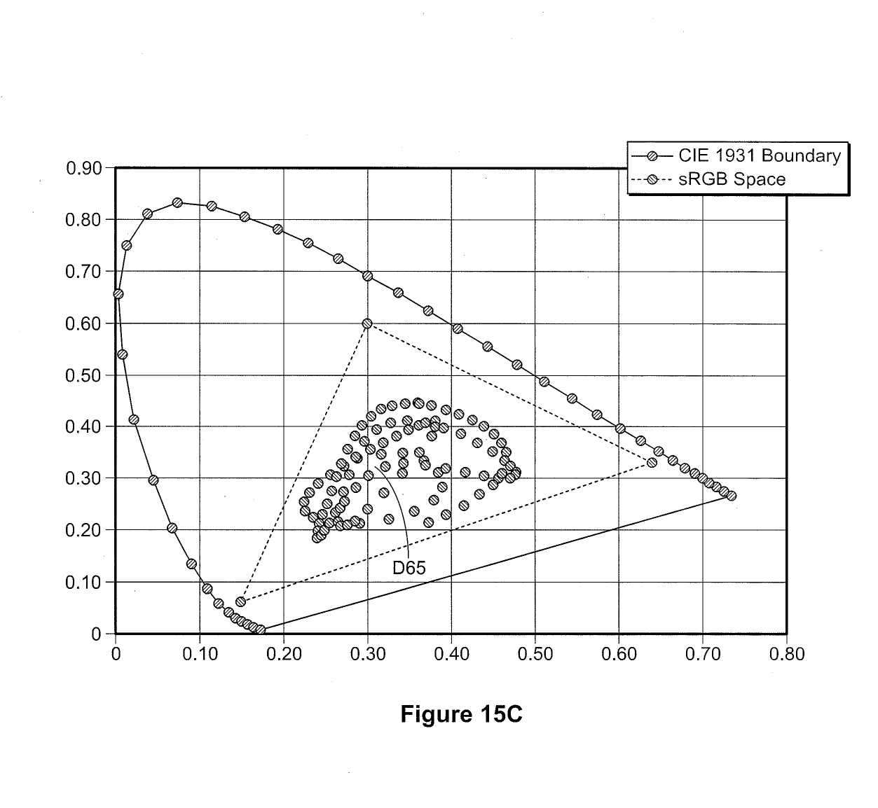

FIGS. 15A-C are chromaticity diagrams illustrating color spirals for simulated AIMODS utilizing both one gap and two gap designs. In some implementations, the AIMODS can have a configuration similar to AIMOD 1500 illustrated in FIG. 10B. In particular, FIG. 15A illustrates a color spiral for an AIMOD producing 256 colors generated with a variable first gap of zero and a variable second gap having a height stepped from 10 nm to 650 nm. Because in this example the variable first gap is zero, the color spiral of FIG. 15A may also represent one color spiral produced by an AIMOD utilizing a single gap design, such as the AIMOD of FIG. 9.

FIG. 15B illustrates a color spiral for an AIMOD producing 156 colors generated with a first gap height of zero (0) nm and a variable second gap height stepped from 10 nm to 650 nm. Because the first gap height is zero (0) nm, this color spiral may also represent the colors produced by an AIMOD utilizing a single gap design, such as the AIMOD of FIG. 9.

FIG. 15C shows a color spiral for an AIMOD producing 100 colors. The colors are generated with a variable first gap having a height of 150 nm and a variable second gap having a height stepped from 10 nm to 650 nm. Because the AIMOD of FIG. 15C includes a first gap height of 150 nm, the colors produced by the AIMOD may be more desaturated than the colors produced by the AIMOD of FIG. 15B (which utilizes a first variable gap height of zero).

While saturated primary colors may be preferred for use in displays that implement a grey-scaling method such as temporal modulation, saturated colors alone may not produce acceptable images when only spatial dithering is used. Some colors in images may be desaturated, and mixing saturated colors via spatial dithering may not be able to create a sufficient amount of de-saturated colors to achieve a high quality image. Simulations indicate that an AIMOD capable of producing some desaturated primary colors may result in improved spatial dithering using the same or perhaps fewer primary colors as compared to an AIMOD producing only saturated primary colors.

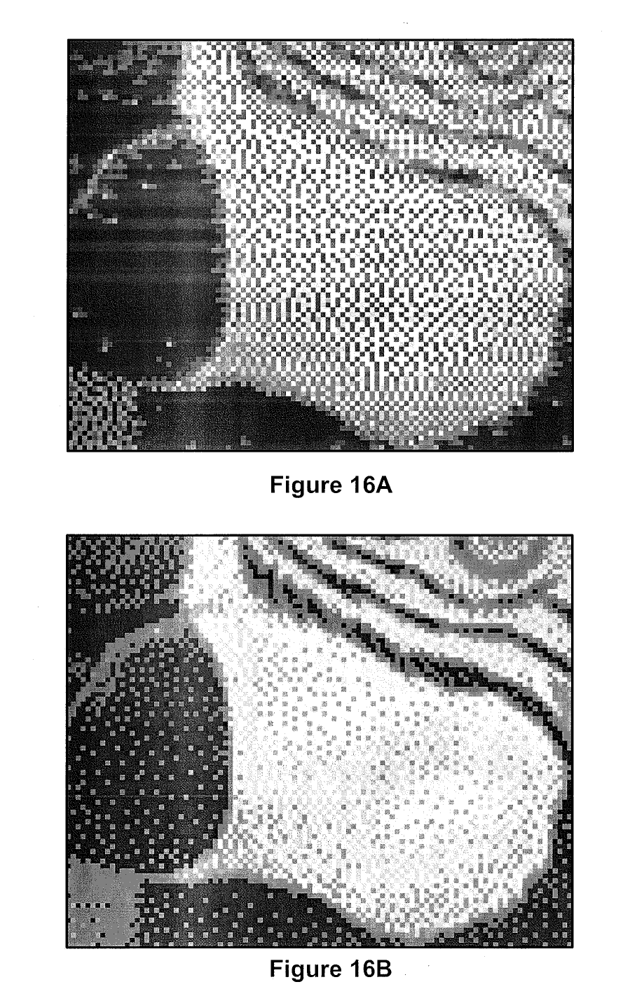

FIGS. 16A and 16B illustrate close up views of white portions of images displayed using AIMODS producing the color spirals of FIGS. 15A and 15C. To render the images of FIGS. 16A and 16B, spatial dithering with Floyd Steinberg error diffusion was used. FIG. 16A, produced using the 256 primary colors of the color spiral from FIG. 15A, shows that the image is not smooth in at least the illustrated white region. Because of the lack of desaturated colors, the spatial dithering must mix only primary colors to achieve the desired color. Because white is highly desaturated, image quality of white regions may be more affected by the lack of desaturated colors in spatial dithering.

FIG. 16B shows a spatially dithered image using an AIMOD that produces both the desaturated colors of the color spiral of FIG. 15C and the saturated colors of FIG. 15B. The image quality of FIG. 16B is improved when compared to FIG. 16A. This is at least partially due to the role desaturated colors play in improving white regions and color smoothness. Without desaturated colors, the spatial dithering algorithm may attempt to spatially mix, for example, magenta with the AIMOD green-tinted white to represent grey-yellowish white colors from the original image. Because the magenta produced by the AIMOD may be too saturated, the image in the region of the dithered color may appear to be very noisy.

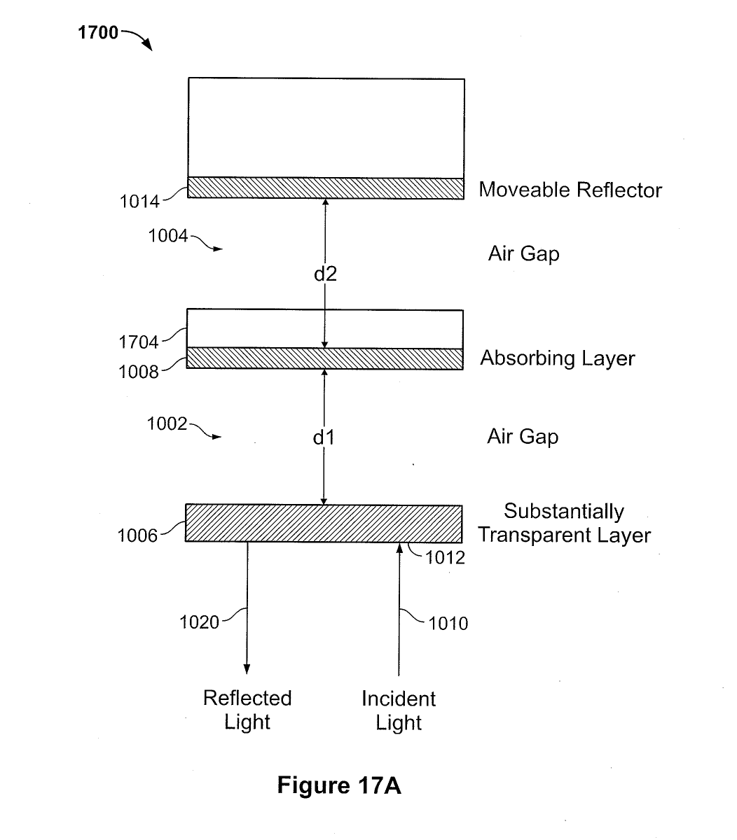

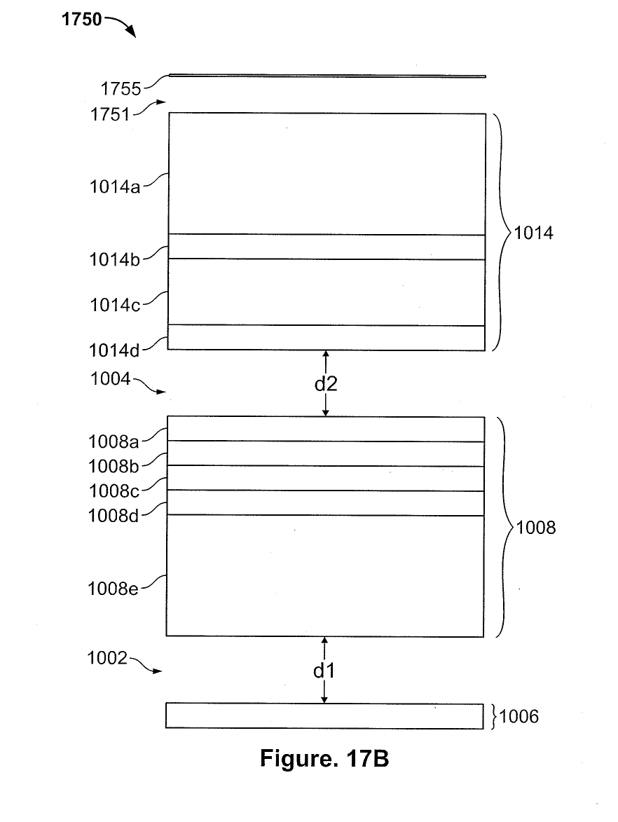

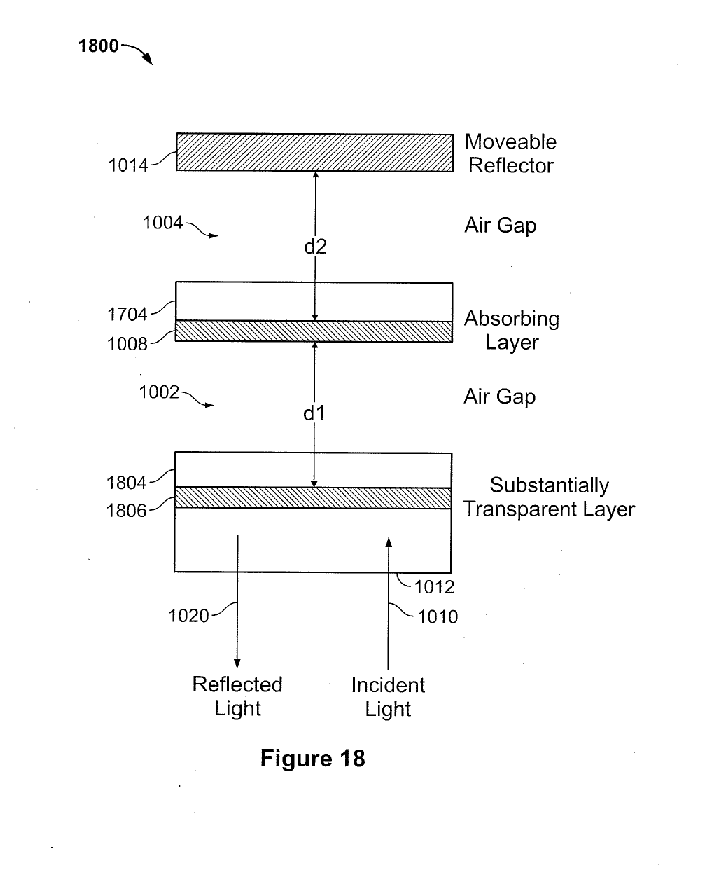

FIG. 17A illustrates an implementation where a movable absorber layer is fabricated on a mechanical supporting dielectric layer. In FIG. 17A, AIMOD 1700 includes a movable reflector or mirror 1014, a light absorbing partially transmissive, movable absorber 1008 (“absorbing layer”), and a second gap 1004. The second gap 1004 is defined as the distance between the movable reflector 1014 and the absorber 1008. At least part of the first gap 1002 and second gap 1004 can include an air gap. The second gap 1004 is configured to have a variable height dimension d2 which changes when the absorber 1008 and the movable reflector 1014 are moved to different positions. In the implementation of FIGS. 17A and 18, the distance d2 is related to d2′, where d2′ is the optical distance between the absorber 1008 and the movable reflector 1014. The optical distance d2′ takes into account the thickness and index of refraction of a dielectric layer 1704, and the penetration depth of light into the movable reflector 1014.

The AIMOD 1700 also includes a substantially transparent substrate structure 1006, and a first gap 1002 disposed between the substrate structure 1006 and the absorber 1008. The first gap 1002 is configured to have a variable height dimension d1, which can change when the absorber 1008 is driven to various positions to change the reflection spectrum of the AIMOD 1700. In some implementations, the absorber 1008 and substrate structure 1006 can have various thickness dimensions as described herein, for example, the absorbing layer 1008 can have a thickness between 3 nm and 15 nm. One or more dielectric layers may be provided on the surface of the absorbing layer. These dielectric layers may be positioned facing the substrate to provide saturated AIMOD colors when the gap 1002 is zero (0) or near zero (0) (e.g., 10 nm).

In the implementation illustrated in FIG. 17A, the AIMOD 1700 further includes a passivation dielectric layer 1704 disposed on the absorber 1008 and between the absorber 1008 and the movable reflector 1014, within the second gap 1004. In some implementations, one or more dielectric layers (not shown) can be disposed on the surface of the absorbing layer facing the substrate. These layers may improve optical performance and provide structural support. In another implementation (not shown), a dielectric layer can be disposed on the absorber 1008 and between the absorber 1008 and the substrate structure 1006 such that it is in the first gap 1002. In some implementations, the dielectric layer can include SiO₂. Such a dielectric layer can be configured to have a thickness dimension of between about 80 nm and about 250 nm in various implementations, for example, 170 nm, at least in the active area of the AIMOD 1700.

FIG. 17B illustrates an implementation including a fourth electrode positioned above the movable stack. Similar to FIG. 17A, AIMOD 1750 includes a movable reflector or mirror 1014, a light absorbing partially transmissive, movable absorber 1008 (“absorbing layer”), and a substantially transparent substrate structure 1006. AIMOD 1750 also includes a first gap 1002 and a second gap 1004 similar to FIG. 17A. AIMOD 1750 also includes a fourth electrode 1755 positioned above the movable reflector 1014 in FIG. 17B. A third gap 1751 is present between the movable reflector 1014 and fourth electrode 1755.

As illustrated in FIG. 17B, movable reflector 1014 may include a layer 1014b composed of a highly reflective metal. In an embodiment, the highly reflective metal may be aluminum. The layer of highly reflective metal may be between 38 nm and 42 nm thick. Movable reflector 1014 may also include two color enhancement dielectric layers 1014c and 1014d. One color enhancement dielectric layer 1014c may have a low refractive index, while the other dielectric layer 1014d may have a high refractive index. In some implementations, layer 1014c may be composed of silicon oxynitride (SiON). In some implementations, layer 1014d may be composed of titanium dioxide (Ti0₂). Layer 1014c may have a thickness of between 70 nm and 74 nm. In other implementations, the thickness of layer 1014d may be between 22 nm and 26 nm. Movable reflector 1014 may also have a mechanical supporting layer 1014a. In some embodiments, layer 1014a may be composed of silicon oxynitride (SiON).

FIG. 17B also illustrates the movable absorber 1008 may also be composed of multiple layers. Movable layer 1008 may include a passivation layer 1008a. In an embodiment, the passivation layer may be composed of aluminum oxide (Al₂O₃). In an embodiment, the passivation layer may be between 8 nm and 10 nm thick. The movable absorber 1008 may also include an absorbing layer 1008b. In an embodiment, the absorbing layer 1008b is composed of a metal. In an embodiment, the metal is vanadium (V). In an embodiment, the absorbing layer 1008b is between 6 nm and 9 nm thick.

FIG. 17B illustrates that the movable absorber 1008 may also be composed of three color enhancement dielectric layers 1008c-e. These layers may be composed of one or more of silicon dioxide (SiO₂), and silicon nitride (Si₃N₄). For example, in an embodiment, layer 1008c may be silicon dioxide (Si0₂). In an embodiment, layer 1008c may be between 26 and 28 nm thick. For example, layer 1008c may be 27 nm thick. In an embodiment, layer 1008d may be composed of silicon nitride (Si₃N₄). In an embodiment, a layer of silicon nitride may be between 20 nm and 24 nm thick. For example, layer 1008d may be 22 nm thick. In an embodiment, layer 1008e may be composed of silicon dioxide (Si0₂). In an embodiment, layer 1008e may be between 175 nm and 225 nm thick. For example, layer 1008e may be 200 nm thick. The three dielectric layers 1008c-e may also provide mechanical support for the movable absorber 1008.

Still referring to FIG. 17B, the substantially transparent substrate structure 1006 may be composed of a transparent conductor such as indium tin oxide (ITO). In an embodiment, the transparent substrate structure 1006 may be between 4 nm and 6 nm thick. For example, in an embodiment, transparent substrate structure 1006 is 5 nm thick. When a drive signal (not shown) is applied to the transparent conductor of layer 1006, the movable absorber 1008 may be pulled toward the substrate 1006. In an embodiment, the movable absorber 1008 may contact the substrate 1006. When this occurs, distance d1 may be substantially zero.

As shown in FIG. 17B, electrode 1755 may be disposed above the movable stack 1014. When a drive signal is applied to electrode 1755 (not shown), the movable reflector 1014 may be pulled towards the electrode 1755.

FIG. 18 shows an example of a cross-sectional schematic illustration of another implementation of an AIMOD 1800 that includes two variable height gaps. The AIMOD 1800 includes a stationary substantially transparent substrate structure 1006 having a conductive layer (either as part of the substrate structure or disposed thereon), and a variable first gap 1002 disposed between the substrate structure 1006 and the absorber 1008. The first gap 1002 is configured to have a variable height dimension d1, which can change when the absorber 1008 is driven to various positions to change the reflection spectrum of the AIMOD 1800. AIMOD 1800 also includes a movable reflector (or mirror) 1014, a light absorbing, partially transmissive movable absorber 1008 (“absorbing layer”), and a variable second gap 1004. At least part of the first gap 1002 and second gap 1004 can include an air gap. The second gap 1004 is configured to have a variable height dimension d2 which changes when the absorber 1008 and the movable reflector 1014 are moved to different positions. In some implementations, the absorber 1008 and the substrate structure 1006 can have various thickness dimensions as described herein. For example, the absorber 1008 can have a thickness dimension in an active area of the AIMOD 1800 of about 3 nm to about 15 nm.

In the implementation illustrated in FIG. 18, the AIMOD 1800 further includes a dielectric passivation layer 1704 disposed on the absorber 1008 and between the absorber 1008 and the movable reflector 1014, within the second gap 1004. In another implementation (not shown), one or more dielectric layers can be disposed on the absorber 1008 and between the absorber 1008 and the substrate structure 1006 such that they are in the first gap 1002. The dielectric layers may contribute to the color performance of the AIMOD 1800. The dielectric layers may also provide a mechanical supporting structure. The AIMOD 1800 also includes a second dielectric layer 1804 disposed on the substrate structure 1006, such that the second dielectric layer 1804 is between the substrate structure 1006 and the absorber 1008. In some implementations, such dielectric layers can be configured to have a thickness dimension of between about 10 nm and about 50 nm, for example, 25 nm, at least in the active area of the AIMOD 1800. While FIGS. 17 and 18, and the corresponding description, disclose a display element that includes two variable gaps, implementations of the disclosed structure where the gaps are not variable but have the movable reflector and absorbing layer in fixed positions such that the display element provides a mix of light at certain wavelengths are also contemplated. Such static implementations can include first and second gaps 1002 and 1004 that are not filled by air, but are rather filled by a dielectric, such as silicon dioxide (SiO₂).

FIG. 19 shows an example of a cross-sectional schematic illustration of an AIMOD 1900 having two variable gaps and an implementation for changing the height of the gaps. FIG. 20 also shows an example of a cross-sectional schematic illustration of an AIMOD 2000 having two gaps and an implementation for changing the height of the gaps. Referring to both FIGS. 19 and 20, the illustrated AIMODs 1900 and 2000 are each configured similarly to the AIMOD illustrated in FIG. 18, having a movable reflector 1014, a light absorbing, partially transmissive movable absorber 1008 (“absorbing layer”), a second gap 1004 disposed between and defined by the movable reflector 1014 and the absorber 1008, a stationary substantially transparent substrate structure 1006 having a conductive layer (either as part of the substrate structure or disposed thereon), a first gap 1002 disposed between and defined by the substrate structure 1006 and the absorber 1008, and a dielectric layer 1704 disposed on the absorber 1008 and between the absorber 1008 and the movable reflector 1014, within the second gap 1004. In FIGS. 19 and 20, at least part of the second gap 1004 and at least part of the first gap 1002 can include an air gap. The second gap 1004 is configured to have a variable height dimension d2 which changes when the absorber 1008 or the movable reflector 1014 are moved to different positions. The first gap 1002 is configured to have a variable height dimension d1 which changes when the absorber 1008 is moved to different positions relative to the substrate structure 1006. In the implementation of FIGS. 19 and 20, the distance d2 is related to d2′, where d2′ is the optical distance between the absorber 1008 and the movable reflector 1014. The optical distance d2′ takes into account the thickness and index of refraction of a dielectric layer 1704, and the penetration depth of light into the movable reflector 1014. Also, the distance d1 is related to d1′, where d1′ is the optical distance between the absorber 1008 and the substrate structure 1006. The optical distance d1′ takes into account the thickness and index of refraction of a dielectric layer 1804.

In FIG. 19, AIMOD 1900 also includes a flexible structure referred to as springs (or hinges) 1902 mechanically attached to the movable reflector 1014 and springs 1904 mechanically attached to the absorber 1008. In this implementation, the movable reflector 1014, the absorber 1008, and the substrate structure 1006 are configured as electrodes. In other words, such an implementation can be described as having three electrodes (a first, second and third electrode) and these electrodes can be used to drive the AIMOD. The AIMOD 1900 also includes at least one electrical connection 1906 connected to the conductive layer of the substrate structure 1006. Springs 1902 and 1904 can electrically couple the movable reflector 1014 electrode and the absorber 1008 electrode, respectively, to a drive circuit (such as the drive circuit illustrated in FIG. 2). The drive circuit can be configured to apply a voltage V1 across the conductive layer 1006 and the absorber 1008 to drive the absorber 1008. The movable reflector 1014 and the conductive layer of the substrate structure 1006, via springs 1902 and electrical connection 1906 can be electrically coupled to a drive circuit (e.g., FIG. 2) which can be configured to apply a voltage V2 across the conductive layer 1006 and the reflector 1014 to drive the reflector 1014. Accordingly, applying driving voltages V1 and V2 can move the movable absorber 1008 and the movable reflector 1014 to position the absorber 1008 and the movable reflector 1014 at desired distances from the substrate structure 1006 such that an appropriate mix of desired wavelengths of light are reflected from the AIMOD 1900.

FIG. 20 also shows an example of a cross-sectional schematic illustration of an AIMOD having two variable gaps and an implementation for changing the height of the gaps. The AIMOD 2000 can include similar structural elements as the AIMOD 1900. The movable reflector 1014, a light absorbing, partially transmissive movable absorber 1008 (“absorbing layer”), and a conductive layer of a substrate structure 1006 can be driving electrodes of the AIMOD 2000. However, in this implementation, the absorber 1008 is connected to ground or another common electrical point relative to the voltage V2 (applied across the movable reflector 1014 and the absorber 1008) and V1 (applied across the conductive layer of the substrate structure 1006 and the absorber 1008). In some implementations, springs 2004 electrically connect the absorber 1008 to ground. The absorber 1008 and the substrate structure 1006 are electrically coupled to a drive circuit configured to apply a voltage V1 across the absorber 1008 and the substrate structure 1006. The absorber 1008 and the movable reflector 1014 are electrically coupled to a drive circuit configured to apply a voltage V2 across the absorber 1008 and the movable reflector 1014. Applying driving voltages V1 and V2 can move the movable absorber 1008 and the movable reflector 1014 to position the absorber 1008 and the movable reflector 1014 at a desired distance d2 from each other, and move the absorber 1008 relative to the stationary substrate structure 1006 to position the absorber 1008 a desired distance d1 from the stationary conductive substrate structure 1006 and the desired wavelengths of light are reflected from the AIMOD 2000.

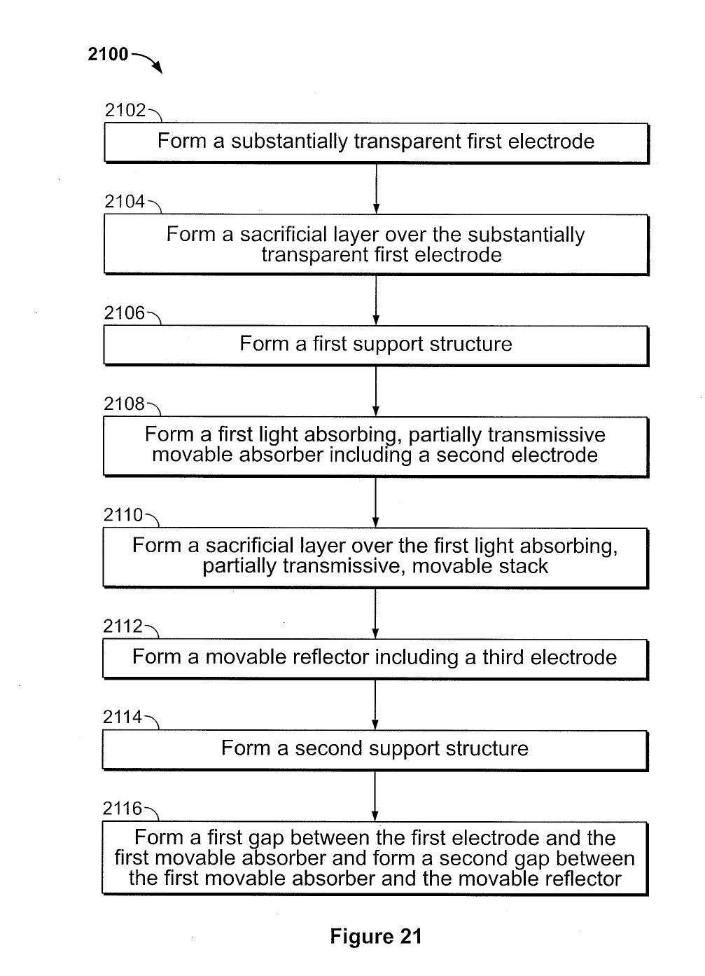

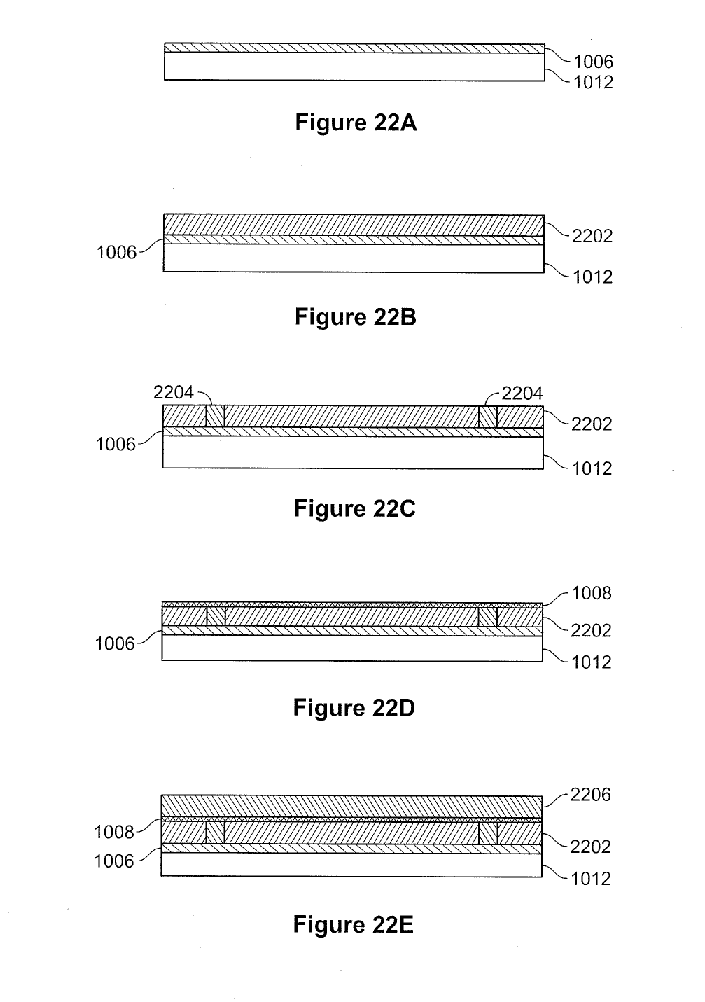

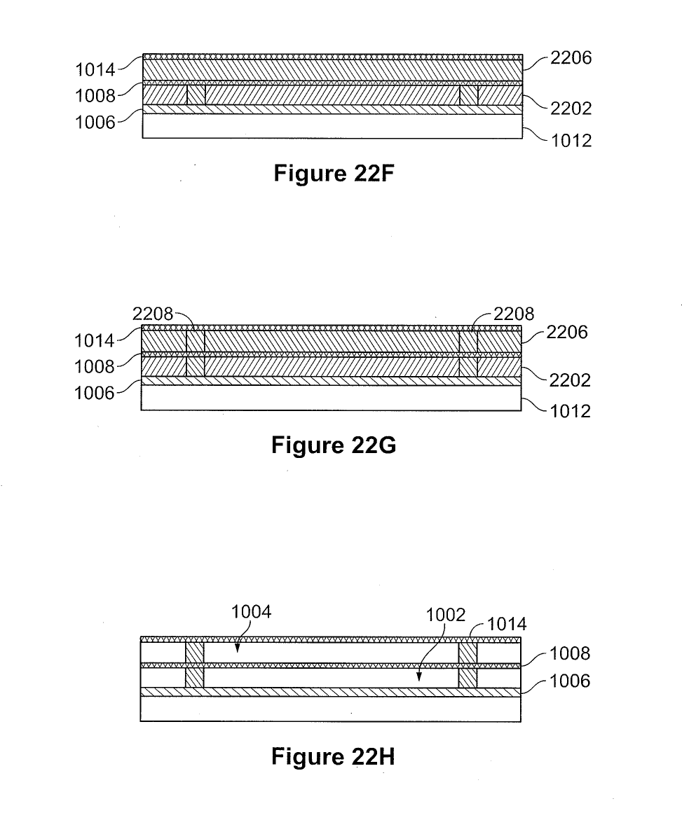

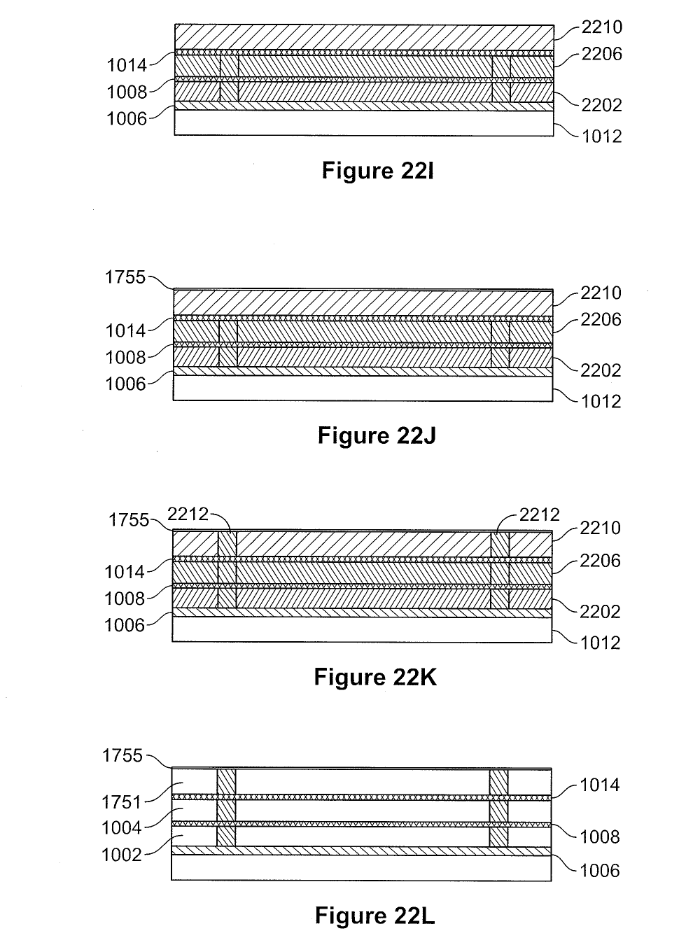

FIG. 21 shows an example of a flow diagram illustrating a manufacturing process for an AIMOD utilizing a two gap design. FIGS. 22A-22G are cross-sectional schematic illustrations of various stages in a method of making an AIMOD that utilizes a variable two gap design. Process 2100 shown in FIG. 21, illustrates a manufacturing process for an AIMOD that has two gaps, such as the example implementation illustrated in FIGS. 10A and 10B. Similar processes can be used to form the other AIMOD implementations described herein. The manufacturing process 2100 can include, but is not limited to, the manufacturing techniques and materials described in reference to FIGS. 8A-8E.

Referring to FIG. 21, in block 2102 a transmissive conductor layer 1009 is formed. In some implementations, the transmissive conductor layer 1009 can be formed on a substrate 1012, or it can be part of the substrate structure. FIG. 22A illustrates an unfinished AIMOD device after completion of block 2102. In some implementations, deposition techniques such as physical vapor deposition (PVD), plasma enhanced chemical vapor deposition (PECVD), and chemical vapor deposition (CVD) can be used to form the transmissive conductor layer 1009. The process 2100 continues at block 2104 with the formation of a sacrificial layer 2202 over the transmissive conductor layer 1009. FIG. 22B illustrates an unfinished AIMOD device after completion of block 2104. In some implementations, deposition techniques such as PVD, PECVD, thermal CVD or spin-coating can be used to form the sacrificial layer 2202. The process 2100 continues at block 2106 with the formation of a first support structure 2204. FIG. 22C illustrates an unfinished AIMOD device after completion of block 2106. Such support structure can include a plurality of support structures 2204 that are disposed on one or more sides of a display element. The formation of the support structure 2204 can include patterning the sacrificial layer 2202 to form at least one support structure aperture, then depositing a material into the aperture to form the support structure 2204.

The process continues at block 2108 with the formation of a light absorbing, partially transmissive movable absorber 1008. In an embodiment, the movable absorber may be metal. In an embodiment, color enhancement layers may be formed prior to the formation of the movable absorber 1008. These color enhancement layers may serve as a strengthening dielectric layer, such as dielectric layer 1704 in FIG. 17A. FIG. 22D illustrates an unfinished AIMOD device after completion of block 2108. In some implementations, the light absorbing, partially transmissive movable absorber 1008 can include MoCr, and the light absorbing, partially transmissive movable absorber 1008 can have a thickness of between about 3 nm and 15 nm. The thickness of the entire stack, including the absorbing metal and the color-enhancement/mechanical-supporting dielectric layers may be about 150 nm to about 250 nm. In some implementations, a passivation layer, e.g., aluminum oxide (Al₂O₃) of about 10 nm is deposed on top of the absorbing metal layer. The process 2100 continues at block 2110 with the formation of another sacrificial layer 2206 over the light absorbing, partially transmissive movable absorber 1008, using for example, the techniques indicated above. FIG. 22E illustrates an unfinished AIMOD device after completion of block 2110.

The process 2100 continues at block 2112 with the formation of a movable reflector 1014 including a third electrode. FIG. 22F illustrates an unfinished AIMOD device after completion of block 2112. The process 2100 continues at block 2114 with the formation of a second support structure 2208. FIG. 22G illustrates an unfinished AIMOD device after completion of block 2114. The second support structure 2208 can, in some implementations, be formed by patterning the sacrificial layer 2206 formed over the light absorbing, partially transmissive movable absorber 1008 to form at least one support structure aperture, then depositing a material into the aperture to form the support structure 2208.

The process 2100 continues at block 2116 with the formation of a first gap 1002 between the transmissive conductor layer 1009 and the light absorbing, partially transmissive movable absorber 1008, and a second gap 1004 between the light absorbing, partially transmissive movable absorber 1008 and the movable reflector 1014. FIG. 22H illustrates an unfinished AIMOD device after completion of block 2116. The gaps 1002 and 1004 can be formed by exposing the sacrificial layers to an etchant. During the process 2100, apertures (not shown) that allow the sacrificial layers 2202 and 2206 to be exposed to an etchant may also be formed in the AIMOD. In different implementations, at least two of the reflector 1014, and the light absorbing, partially transmissive movable absorber 1008, are formed to be movable as described herein so that the height dimensions of a first and second gap can be correspondingly changed (increased or decreased) to affect the spectrum of wavelengths of light that are reflected by a display element.

In an embodiment, before gaps 1002 and 1004 are formed in block 2116, process 2100 includes formation of a sacrificial layer 2210 over the movable reflector 1014. FIG. 22I illustrates an unfinished AIMOD device after formation of sacrificial layer 2210. Process 2100 in this embodiment may further include formation of a fourth electrode 1755 over the sacrificial layer 2210. FIG. 22J illustrates an unfinished AIMOD device after formation of the fourth electrode 1755. Process 2100 in this embodiment may further include formation of a third support structure 2212. FIG. 22K illustrates an unfinished AIMOD device after formation of the third support structure 2212.

In this embodiment, after sacrificial layer 2210, the fourth electrode 1755, and the fourth support structure 2212 are formed, gaps 1002, 1004, and third gap 1751 may be formed by exposing the sacrificial layers to an etchant as described in block 2116. FIG. 22L illustrates an unfinished AIMOD device after completion of this embodiment of block 2116.

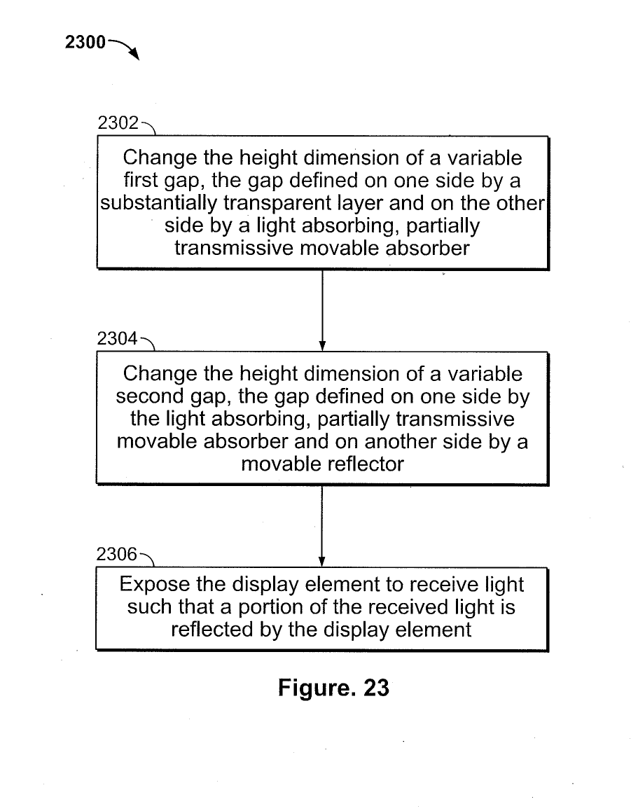

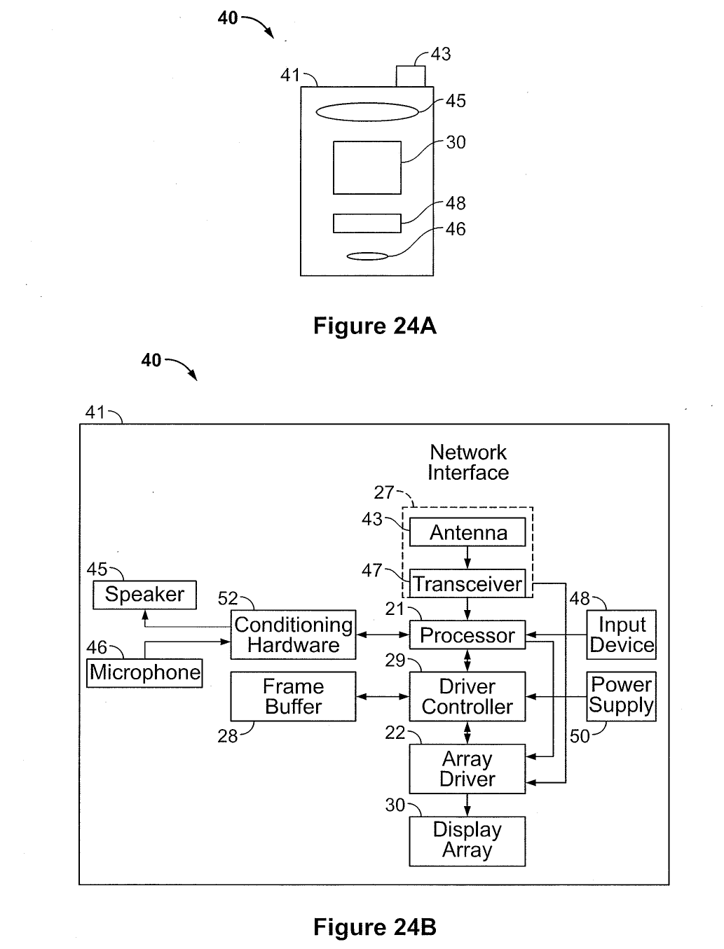

FIG. 23 shows an example of a flow diagram illustrating a method of displaying information on a display element. In block 2302, the process 2300 includes changing a height dimension d1 of a variable first gap, the first gap defined on one side by a substrate structure and on another side by a light absorbing, partially transmissive movable absorber (“absorbing layer”). Depending on the particular implementation, this can be accomplished by driving the light absorbing, partially transmissive movable absorber to a different position relative to the substrate structure. The absorbing layer and/or the transmissive conductor layer 1009 can be driven by drive signals (voltages) provided by a driving circuit, for example, as illustrated in FIGS. 2 and 24B.

Moving to block 2304, the process 2300 further includes changing a height dimension d2 of a variable second gap, the second gap defined on one side by the light absorbing, partially transmissive movable absorber and on another side by a movable reflector. Depending on the implementation, this can be accomplished by moving the movable reflector 1014.

Referring to FIG. 10B, blocks 2302 and 2304 described above may be performed by moving the light absorbing, partially transmissive movable absorber 1008 and/or the movable reflector 1014. In any configuration, moving the light absorbing, partially transmissive movable absorber 1008 is coordinated with moving the movable reflector 1014 when adjusting the height dimensions of the gaps. For example, because the position of the light absorbing, partially transmissive movable absorber 1008 affects the height of both the first and second gaps, movement of the light absorbing, partially transmissive movable absorber may be coordinated with movement of the movable reflector to achieve a desired gap size for d2. The movable layers may be moved at least partially synchronously to achieve the desired height dimensions.

Moving to optional block 2306, the process 2300 includes exposing the display element to receive light such that a portion of the received light is reflected from the display element. Changing the first and second variable gap height dimensions d1 and d2, respectively, places the display element in a display state to have a certain appearance. In such a display state a portion of the received light propagates into the display element, through the substrate structure and the light absorbing, partially transmissive layer, to the movable reflector (mirror).

A portion of a spectrum of wavelengths of the light reflected from the mirror are absorbed by the light absorbing, partially transmissive layer based at least in part on the second gap height dimension d2 (which positions the absorbing layer at different positions relative to the standing wave field intensity of the reflected wavelengths). Other non-absorbed light propagates through the absorbing layer out of the display element.

Another portion of the received light propagates into the display element and is reflected by the surface of the light absorbing, partially transmissive layer. This light then propagates out of the display element, and mixes with the non-absorbed light mentioned above to form a perceived color of light reflected by the display.

FIGS. 24A and 24B show examples of system block diagrams illustrating a display device that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

In some implementations, the devices described herein may include a display 30 including a display array of electromechanical devices, a processor 21 that is configured to communicate with the display 30, the processor 21 being configured to process image data, and a memory device that is configured to communicate with the processor 21. Such devices further may include a driver circuit, which may include a driver controller 29, an array driver 22, and/or a frame buffer 28, configured to send at least one signal to the display 30. In some implementations, such devices may include a controller 29 configured to send at least a portion of the image data to the driver circuit. Some implementations of these devices may include an image source module (for example, input device 48) configured to send the image data to the processor 21, and the image source module may include at least one of a receiver, a transceiver, and a transmitter. In some implementations, such devices may include an input device 48 configured to receive input data and to communicate the input data to the processor 21. In some of the devices described herein that include a first and third electrode, the first and third electrodes can be configured to receive a driving signal from the driver circuit.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 24B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions and processes described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method, algorithm or manufacturing process disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical device, comprising:
a substantially transparent over a visible wavelength spectrum first electrode disposed on a substrate;
a light-absorbing, partially transmissive movable stack including a second electrode, the movable stack being positionable at a variable first distance from the first electrode to form a variable first gap between the movable stack and the first electrode, wherein the device is configured to move the movable stack to at least two different positions, each position being a different distance from the first electrode; and
a movable reflector including a third electrode, the movable reflector disposed such that the movable stack is between the first electrode and the movable reflector and such that the movable reflector is at a variable second distance from the movable stack to form a variable second gap between the movable reflector and the movable stack, wherein the device is configured to move the movable reflector to a plurality of positions such that the second distance is between about zero (0) nm and 650 nm.

2. The device of claim 1, further comprising a fourth electrode disposed such that the movable reflector is between the fourth electrode and the movable stack.

3. The device of claim 1, wherein the device is configured to move the movable stack to change the first distance to either one of two different distances.

4. The device of claim 1, wherein the at least two different positions place the movable stack at a minimum distance from the first electrode when the movable stack is in an actuated state and a maximum distance from the first electrode when the movable stack is in a relaxed state.

5. The device of claim 1, wherein the device is configured to position the movable reflector and the movable stack such that the second distance is between about 10 nm and 650 nm and the first distance is at either between about zero (0) nm and 10 nm or between about 100 nm and 200 nm.

6. The device of claim 1, wherein the movable reflector includes, in relative order, a layer of metal film, a layer of low refractive index thin film, a layer of high refractive index dielectric film.

7. The device of claim 6, wherein the movable reflector further includes a mechanically supporting dielectric layer disposed such that the layer of high refractive index dielectric film is between the mechanically supporting dielectric layer and the low refractive index thin film.

8. The device of claim 7, wherein the layer of metal film includes aluminum (Al), the layer of low refractive index thin film includes silicon oxynitride (SiON), and the layer of high refractive index dielectric film includes titanium dioxide (TiO₂), and the mechanical supporting dielectric layer includes silicon oxynitride (SiON).

9. The device of claim 1, wherein the movable stack includes, in relative order, a layer of passivation thin film, a layer of absorbing metal film, a layer of low refractive index thin film, a layer of high refractive index film, and a second layer of thin film with its refractive index identical to the substrate material, the second layer of thin film having a thickness dimension of between about 150 nm and 250 nm.

10. The device of claim 7, wherein the layer of passivation thin film includes aluminum oxide (Al₂O₃)), the layer of absorbing metal film includes vanadium (V), the layer of low refractive index thin film includes silicon dioxide (SiO₂), the layer of high refractive index film includes silicon nitride (Si₃N₄), and the second layer of thin film includes silicon dioxide (SiO₂).

11. The device of claim 1, wherein the device is configured to apply a voltage across the movable stack and the first electrode to adjust the first distance, and wherein the device is configured to apply a voltage across the movable reflector and the movable stack to adjust the second distance.

12. The device of claim 1, wherein the device is configured to adjust the second distance to one of at least five unique distances.

13. The device of claim 1, further comprising:
a display including an array of the electromechanical devices;
a processor that is configured to communicate with the display, the processor being configured to process image data; and
a memory device that is configured to communicate with the processor.

14. The device as recited in claim 13, further comprising a driver circuit configured to send at least one signal to the display.

15. The device as recited in claim 12, further comprising a controller configured to send at least a portion of the image data to the driver circuit.

16. The device as recited in claim 13, further comprising an image source module configured to send the image data to the processor.

17. The device as recited in claim 14, wherein the image source module includes at least one of a receiver, a transceiver, and a transmitter.

18. The device as recited in claim 13, further comprising an input device configured to receive input data and to communicate the input data to the processor.

19. The device of claim 13, wherein the first and third electrodes are configured to receive a driving signal from the driver circuit.

20. An electromechanical display device, comprising:
a transmissive first electrode substantially transparent over a visible wavelength spectrum disposed on a substrate;
a movable means for partially transmitting and partially absorbing light positionable at a variable first distance from the first electrode to form a variable first gap between the movable stack and the first electrode, wherein the display device is configured to move the partially transmitting and partially absorbing means to at least two different positions, each position being a different distance from the first electrode; and
means for reflecting light disposed such that the movable means is between the first electrode and the reflecting means, and the reflecting means positionable at a variable second distance from the movable means to form a variable second gap between the movable means and the means for reflecting light, wherein the display device is configured to move the reflecting means to a plurality of positions such that the second distance is between 10 nm and 650 nm.

21. The device of claim 20, wherein the partially transmitting and partially absorbing means comprises a movable stack including an absorbing layer having a thickness of about 10 nm and a second electrode.

22. The device of claim 20, wherein the reflecting light means comprises a movable reflector stack including a third electrode.

23. A method of forming an electromechanical apparatus, comprising:
forming a first electrode that is substantially transparent over a visible wavelength spectrum on a substrate;
forming a sacrificial layer over the first electrode;
forming a first support structure;
forming a first light absorbing, partially transmissive movable stack including a second electrode;
forming a sacrificial layer over the first light absorbing, partially transmissive, movable stack;
forming a movable reflector including a third electrode;
forming a second support structure; and
forming a first gap between the first electrode and the first movable stack and a second gap between the first movable stack and the movable reflector.

24. The method of claim 23, further comprising:
forming a sacrificial layer over the movable reflector;
forming a fourth electrode;
forming a third support structure; and
forming a third gap between the movable reflector and the fourth electrode.

25. A non-transitory, computer readable storage medium having instructions stored thereon that cause a processing circuit to perform a method of displaying light on a display element, comprising:
changing a variable first gap to between 0 and 10 nm or between 150 nm and 250 nm, the first gap defined on one side by a first electrode that is substantially transparent in a visible wavelength spectrum, and on the other side by a light-absorbing, partially transmissive movable stack including a second electrode;
changing a variable second gap to between 0 and 650 nm, the second gap defined on one side by the light-absorbing, partially transmissive movable stack and on another side by a movable reflector including a third electrode; and
receiving light such that at least a portion of the received light propagates through the first gap and the second gap, reflects from the movable reflector and propagates back through the second gap and first gap and out of the display element, and a portion of the received light is reflected by the movable stack and propagates out of the display element,
wherein changing the first gap and the second gap changes a characteristic of light reflected from the display element.

26. The computer readable storage medium of claim 25, wherein saturated colors are reflected from the display element when the first gap is between 0 and 10 nm and desaturated colors are reflected from the display element when the first gap is between 150 nm and 250 nm.

27. The computer readable storage medium of claim 25, wherein a height dimension of the first gap and a height dimension of the second gap are synchronously changed.

28. The computer readable storage medium of claim 25, wherein the movable reflector and the movable stack are positioned such that the second gap is between about 10 nm and 650 nm and the first gap is at either between about zero (0) nm and 10 nm or between about 100 nm and 200 nm.

29. The computer readable storage medium of claim 25, wherein the movable reflector includes, in relative order, a layer of metal film, a layer of low refractive index thin film, and a layer of high refractive index dielectric film.

30. The computer readable storage medium of claim 29, wherein the layer of metal film includes aluminum (Al), the layer of low refractive index thin film includes silicon oxynitride (SiNO), and the layer of high refractive index dielectric film includes titanium dioxide (TiO₂).

31. The computer readable storage medium of claim 25, wherein changing a height dimension (d1) of the first gap comprises changing a voltage across the first electrode and the second electrode, and changing the height dimension (d2) of the second gap comprises changing a voltage across the second electrode and the third electrode.
